(19) United States
(12) Patent Application Publication
(10) Pub. No.: US 2003/0069874 A1
(43) Pub. Date: Apr. 10, 2003

(54) Method and system to automate the updating of personal information within a personal information management application and to synchronize such updated personal information management applications

(76) Inventors: Eyal Hertzog, Ramat-gan (IL); Arnon Dinur, Raanan (IL)

Correspondence Address: Andre L Marais, Blakely Sokoloff Taylor & Zafman LLP, 12400 Wilshire Boulevard 7th Floor, Los Angeles, CA, 90025, US

(21) Appl. No.: 09/565,641

(22) Filed: May 5, 2000

Related U.S. Application Data
(60) Provisional application No. 60/132,560, filed on May 5, 1999.
(60) Provisional application No. 60/162,499, filed on Oct. 29, 1999.

(51) Int. Cl. G06F 7/00

(52) U.S. Cl. 707/1

(57) ABSTRACT

Within a database of personal contact information that is accessed by a Personal Information Management (PIM) application, or contact management application, multiple information sets for a specified field or fields of personal information may be stored for a user of the PIM. For example, multiple addresses may be stored. For each set of personal information, an associated event occurrence may be defined upon which the relevant set of personal information is recognized by the PIM as being valid. For example, an event occurrence may comprise a time period during which specific address information is valid. Upon occurrence of the relevant event (e.g., the commencement of the time interval), the relevant information is automatically validated for access by the PIM. In this way, a user is able to, in advance, dictate that certain personal information for the user becomes valid upon certain event occurrences. The personal information concerning the user may then be published to multiple further PIMs to update records concerning the user maintained by such multiple further PIMs.

The present application claims the benefit of the filing dates of U.S. provisional applications Nos. 60/132,560 and 60/162,499, filed May 5, 1999 and Oct. 29, 1999, respectively.

### FIELD OF THE INVENTION

The present invention relates generally to the field of personal information management and, more specifically, to the publication and synchronization of personal information, such as contact and address information, between multiple users connected to a network, such as the Internet.

### BACKGROUND OF THE INVENTION

With the increasing movement towards the maintenance of personal information, such as personal address, contact and calendar information on personal computers (PCs) and Personal Digital Assistance (PDAs), the need to maintain multiple, synchronized copies of such personal information has increased. For example, a particular user may require his or her personal information to be stored on, and accessible from, a personal computer in the home environment, a personal computer in the work environment and a portable PDA that the user carries on his or her person. A user may also maintain a back-up copy of personal information on a diskette or at a remote location accessible via a network. For example, the company @Backup Corporation of San Diego, Calif., (www.backup.com) provides the ability for a user to back-up a PC, which may store personal information, over the Internet.

Where a user has multiple devices each storing a local copy of personal information, it is desirable that all copies of the personal information stored on the various devices can be synchronized in an easy and convenient manner, as the management and maintenance of multiple copies of the personal information would otherwise become cumbersome. To this end, a number of software products are available that synchronize personal information stored by, for example, a Personal Information Manager (PIM) application resident on a computer system and a PDA. Specifically, Puma Technology, Inc. of San Jose, Calif., developed and markets the Intellisync software products that facilitate synchronization of personal information between a PDA (e.g., the Palm PDAs manufactured by 3Com Corporation of Santa Clara, Calif., or the numerous PDAs that operate under the Windows CE operating system developed by Microsoft Corporation of Redmond, Wash.) and PC-based PIMs (e.g., Outlook developed by Microsoft Corporation or Lotus Notes distributed by International Business Machines of Armonk, N.Y.). The Intellisync software typically requires that the PDA be connected to the computer system hosting the PIM, with synchronization between the local copies of the personal information being performed via a direct connection between the computer system and the PDA.

A recent service provided on the Internet is the storage and maintenance of personal information on a server, accessible via the Internet. A leading provider of such a service is PlanetAll.com (www.planetall.com) that allows a user to store personal information at a remote server, and to then have the user's personal information automatically included in the on-line address books of other users of the relevant service. This system is advantageous in that the owner of the personal information is responsible for maintenance thereof, and the user may, simply by changing his or her personal information stored on the server, change the information that is viewable in the address books of other users of the service. PlanetAll.com furthermore provides the ability to synchronize personal information maintained within a PIM (e.g., Microsoft Outlook) with the personal information stored on the remote server. To this end, Intellisync for PlanetAll.com, developed by Puma Technology, Incorporated, is downloadable from the PlanetAll web site.

A number of web portals (e.g., Yahoo! Of Santa Clara, Calif. and Excite Incorporated of Redwood City, Calif.) have incorporated address book and calendering features into the services provided by these portals. For example, Yahoo! Incorporated provides Yahoo! Address Book, Yahoo! Calendar and Yahoo! To Do List services utilizing which a user can store address, calendar and to do information on a remote server operated by Yahoo! Incorporated. These web portals further offer synchronization software for free download from their respective web sites, this synchronization software providing the capability to synchronize copies of personal information stored on PDAs, PIMs and the remote server operated by the web portal. Both Yahoo! Incorporated and Excite Corporation offer the TrueSync synchronization software developed by Starfish, Incorporated of Scotts Valley, Calif.

Finally, eCode.com, Incorporated, offers web-based “business cards”, whereby an “eCode” alias may be communicated to people, the alias being associated with personal information that has been accessible by the recipient of the alias from the web site operated by eCode.com, Inc. (www.ecode.com).

### SUMMARY OF THE INVENTION

According to the present invention, there is provided a method that includes storing first personal information concerning a user to be accessed by a personal information management application, the first personal information being associated with a first event occurrence. Second personal information, also concerning the user, is also stored to be accessed by the personal information application, the second personal information being associated with a second event occurrence. Based on the first event occurrence, the first personal information is then validated for access by the personal information management application. Based on the second event occurrence, the second personal information is validated for access by the personal information management application. Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram illustrating a network environment in which an exemplary embodiment of the present invention may be implemented.

FIG. 2 is a block diagram illustrating architectural details of an exemplary embodiment of a client services module of a client application, according to the present application.

FIG. 3 is a diagrammatic representation of communications between an exemplary client application and an application server.

FIG. 4 is a diagrammatic representation of a set of personal information fields, a number of which are selected to constitute a selection of virtual cards, according to an exemplary embodiment of the present invention.

FIG. 5 provides a diagrammatic representation of data structures containing information regarding a particular user, and a contact of that user, according to an exemplary embodiment.

FIG. 6 is a diagrammatic representation of an exemplary database structure that may be utilized to implement a server database.

FIG. 7 is a diagrammatic representation of an exemplary local database structure that may be maintained by a client application.

FIG. 8 illustrates an exemplary user interface to a personal information management application.

FIGS. 9A-9D illustrate various displays that may be presented within a details information panel (a right panel) within the user interface illustrated in FIG. 8.

FIG. 10A illustrates an exemplary persistent panel into which search text may be inputted.

FIG. 10B illustrates an exemplary options interface that may be utilized to specify, inter alia, search options facilitated by the interface illustrated in FIG. 8.

FIG. 11 is a flow chart illustrating an exemplary method of storing a set of fields of personal information, and recording user selection of a sub-set of these fields as a first information category to be published as a virtual business card or the like.

FIG. 12 illustrates an exemplary information dialog block by which a user may input and specify personal information.

FIG. 13 is an exemplary sound object window that may facilitate the recording of a digital audio recording to be included within the personal information of a publishing user.

FIG. 14 illustrates an exemplary cards window that provides a list of virtual cards (e.g., varying sub-sets of personal information) that have been defined by a publishing user.

FIGS. 15A-15C illustrate various windows that may be displayed to assist in the inputting of new information and the exercising of privacy control regarding newly inputted user information that is inputted by a publishing user.

FIG. 16 is a flow chart illustrating an exemplary method of publishing a selection of personal information from a publishing user to a receiving user.

FIGS. 17-19 illustrate a collection of dialog blocks, or windows, that may be presented to a user to facilitate a change in the virtual card that is assigned to a specific target (or receiving) user.

FIG. 20 illustrates an exemplary permissions panel that provides information regarding a virtual card, or virtual cards, that have been published to a specific target user.

FIG. 21 illustrates a table showing exemplary icons that may be used to indicate pending messages to a user of a personal information management application.

FIGS. 22A-22C, and 23A-23D provide various examples of messages that may be provided to a user of a personal information management application by that application.

FIG. 24 illustrates an exemplary dialog block utilizing which a user may implement a filter mechanism with respect to messages that are displayed within an incoming messages dialog block.

FIG. 25 is a flow chart illustrating an exemplary method of displaying fields of personal information concerning a user in a manner so as to distinguish the personal information that is published and updateable by the first user from personal information that is inputted and updateable by a second user.

FIG. 26 illustrates an exemplary contact window that may be generated to display personal information (e.g., contact information) regarding a target user.

FIG. 27 is a flow chart illustrating an exemplary method of generating a list, or history, of updates to a specific information field of specific personal information.

FIG. 28 illustrates an exemplary update window showing a constructive list of update records.

FIG. 29 is a flow chart illustrating an exemplary method of publishing time-variant personal information from a publishing user to a target user.

FIG. 30 is a flow chart illustrating an exemplary method of retrieving on-line, and possibly real-time or near-real-time information, pertaining to a contact utilizing personal information that is stored in a local database or a server database.

FIG. 31 is a flow chart illustrating an exemplary method of including audio and/or image data within a personal information record, maintained by a personal information management application.

FIG. 32 is a block diagram providing a representation of an exemplary machine in the form of a computer system that may execute a sequence of instructions for performing any of the methodologies discussed in the present application.

### DETAILED DESCRIPTION

A method and system to automate the updating of personal information within a personal information management application, and for synchronizing updated personal information across multiple personal information management applications, are described. In the following description, for purposes of explanation, numerous specific details are set forth in order to provide a thorough understanding of the present invention. It will be evident, however, to one skilled in the art that the present invention may be practiced without these specific details.

For the purposes of the present specification, the term “personal information” shall be taken to include, but not be limited to, address or contact information, calendar information, to do list information, financial information (e.g., credit card numbers), medical information or any other information specific to, and associated with, an individual or organization.

### Architecture

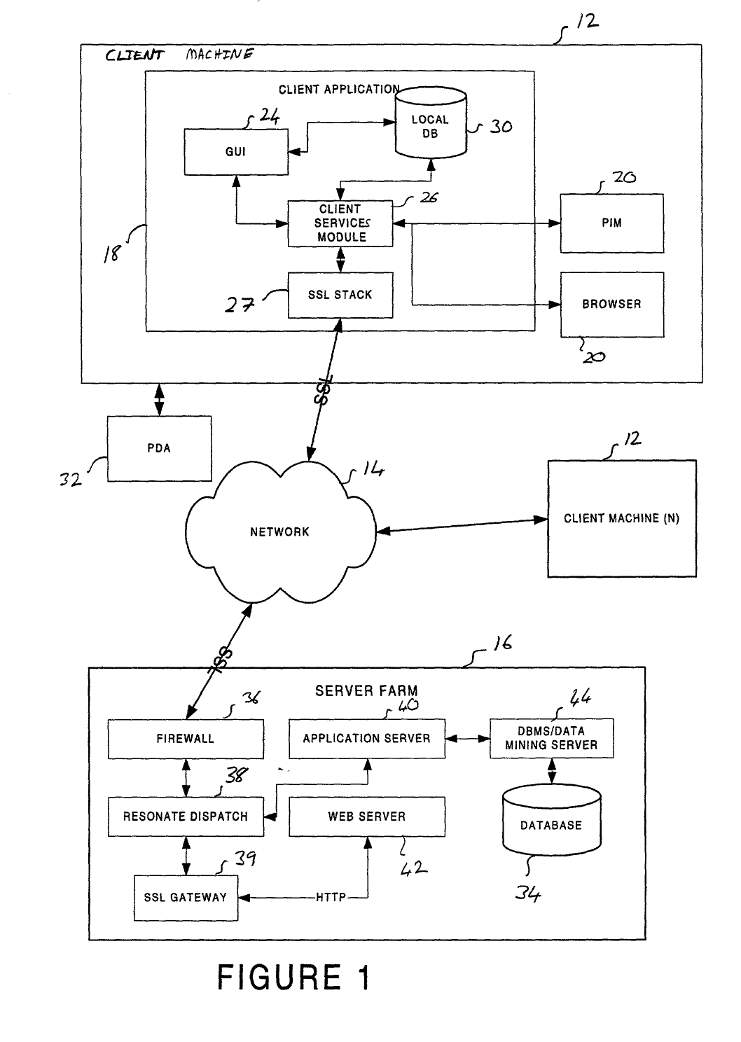

FIG. 1 is a block diagram illustrating a network environment 10 within which an exemplary embodiment of the present invention may be implemented. The network environment 10 is shown to include multiple client machines 12 that are coupled via a network 14 (e.g., the Internet) to a server farm 16. Each client machine 12 may host a client application 18, according to an exemplary embodiment of the present invention, that functions as a Personal Information Manager (PIM) and is responsible for the storage, publishing and synchronization of personal information concerning, for example, a user of the client machine. Each client machine 12 may be a personal computer (PC), a Personal Digital Assistant (PDA) or any other machine capable of being coupled to a network and executing the client application 18.

The client machine 12 is furthermore shown to host a browser 20, such as the Internet Explorer browser developed by Microsoft Corporation, or the Netscape Navigator or Communicator browser developed by Netscape Communications, Incorporated of Mountain View, Calif. The client machine 12 may furthermore host a PIM 22, which may either be a stand-alone application (e.g., Microsoft Outlook) or part of a group-ware application (e.g., Lotus Notes). In an alternative embodiment of the present invention, the client application 18 may be fully integrated with and embodied within the PIM 22, or may itself may constitute a full-function PIM, and thus obviate the need for any further PIM 22.

The client application 18 is constituted by a front-end Graphical User Interface (GUI) 24 that, in an exemplary embodiment of the invention, may present a Windows® user interface where the client machine 12 is operated under a Windows 95/98/NT operating system developed by Microsoft Corporation. The GUI 24 will be described in further detail below, and provides a number of dialog blocks, information displays and interfaces for facilitating the convenient viewing, accessing, publishing and synchronization of personal information. The GUI 24 receives data from a client services module 26, which is accessed using Microsoft COM/DCOM technology.

The client services module 26 provides data services to both the GUI 24 and a local database 30. The client services module 26 is furthermore responsible for executing accesses to the local database 30 within which personal information regarding, for example, a user of the client machine 12 may be maintained. Specifically, the client services module 26 is responsible for the integrity and locking of the local database 30. In an exemplary embodiment, the local database 30 comprises a lightweight object-oriented database developed by ObjectStore.

Components of the client services module 26 (including a synchronization engine 28) are responsible for synchronizing information maintained in the local database 30 with information maintained on a remote database accessible via the network 14 as will be described in further detail below. The client services module 26 communicates via a Secure Socket Layer (SSL) stack 27 over the network 14. Optionally, the client services module 26 also has the capability to synchronize with third party components hosted on, or coupled to, the client machine 12. For example, the client services module 26 may, via the synchronization engine 28, synchronize with the personal information module (PIM) 22 (e.g., Microsoft Outlook or the Palm Desktop) or with a Personal Digital Assistant (PDA) 32 (e.g., the Palm Pilot by 3Com Corporation or any Windows CE device).

As discussed above, the client services module 26 operates to synchronize the local database 30 with a remote database, such as a server database 34 maintained within the server farm 16. The server farm 16 is coupled to the network 14, and receives and transmits communications via a firewall 36, provided by a server farm provider, that implements well-know security features.

A resonate dispatch 38 may be hosted on a pair of Sun Ultra-SPARC machines, from Sun Microsystems of Mountain View, Calif. The resonate dispatch 38 performs load balancing operations between multiple machines on which an application server 40 and a web server 42 are hosted. In an exemplary embodiment, both the application server 40 and the web server 42 may be hosted on a single Sun 450 machine from Sun Microsystems. The application server 40 may be developed utilizing Java technology developed by Sun Microsystems, and serve both the client services module 26 of the client application 18 on the client machine 12, and the web server 42. The application server 40 includes logic that allows a user, accessing the application server 40 via a client machine 12, to access only information for which the user has been granted permission. The application server 40 is furthermore responsible for sending personal information updates to the client services module 26 so as to synchronize the local database 30 with a specific subset of information maintained within the server database 34.

The web server 42 communicates with the resonant dispatch 38 via a SSL gateway 39 that encapsulates and unencapsulates Hypertext Transport Protocol (HTTP) communications issued from and to be received at the web server 42. The web server 42 may also be developed utilizing Java technology, and take advantage of the “Just In Time” (JIT) compiler and Sun Servlets. The application and web servers 42 and 40 provide full access to permitted data within the database 34 to a user of a remote client machine 12 by the browser 20. The application and web servers 42 and 40 further allow access to permitted data within the database 34 from any platform what provides web-browsing capabilities (e.g., client machines 12 operating under the Unix, Macintosh or Windows operating systems).

A Database Management System (DBMS) (also known as a data-mining server) 44 executes complex queries to the database 34 either when prompted or on a scheduled basis. The DBMS 44 may be hosted on a Sun Ultra Enterprise 4500 machine, while the server database 34 may be implemented using a RAID storage device. The server database 34 maintains synchronized copies of the local databases 30 that may be implemented on numerous client machines 12 coupled to the server farm 16, and accordingly the database 34, via the network 14. The server database 34 also records various permissions with respect to personal information by which personal information for a specific user may be accessible by, and accordingly published to, multiple other users. In effect, the server database 34 facilitates a system whereby, for example, an address book of a specific user (i.e., address information that is viewable by the specific user) is populated by information supplied and published by multiple other users. Accordingly, only a single copy of personal information concerning a specific user may exist within the server database 34, but this specific copy is accessible to multiple other users to who an owner user has granted access permission. Further, the present invention envisages that the single copy of personal information for an owner user may be utilized to populate multiple local databases 30 maintained upon respective client machines 12. Accordingly, a local database 30 on a remote client machine 12 may be largely populated by information retrieved from the database 34, and which is maintained by an originator of such information.

### Synchronization Engine and Synchronization Process

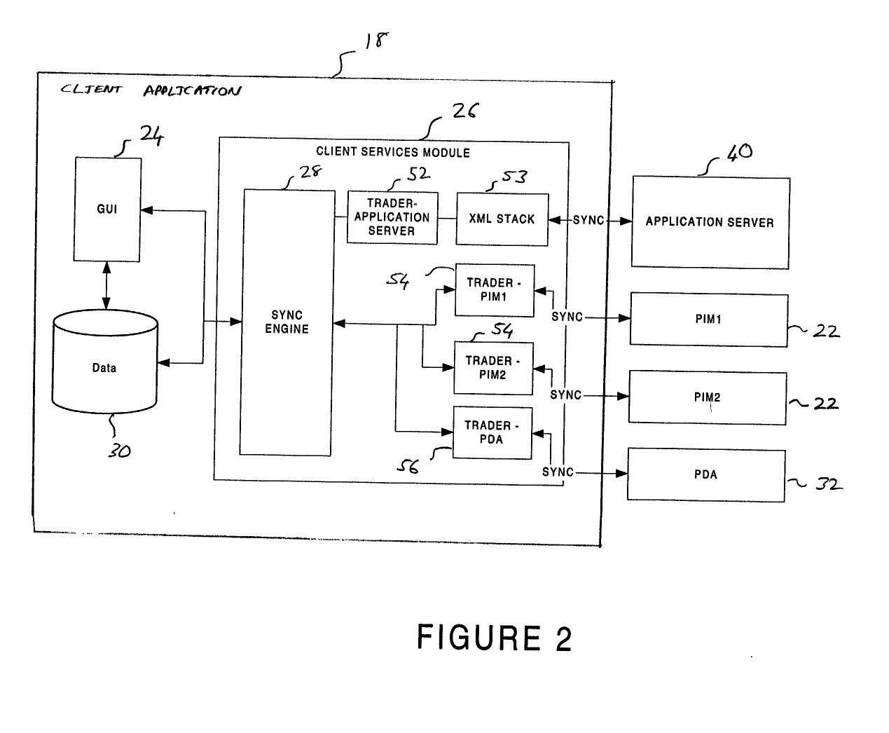

FIG. 2 is a block diagram of an embodiment of the client services module 26, illustrating further architecture details thereof. The synchronization engine 28 is responsible for implementing two different synchronization processes, namely (1) a local synchronization operation wherein the client application 18, within which the module 26 is included, is synchronized with a local PIM 22 or a coupled PDA 32, and a (2) global (or remote) synchronization wherein the client application 18 is synchronized with the application server 40, and the associated server database 34, via the network 14. The synchronization engine 28 furthermore has two modes of operation namely (1) an off-line mode wherein the client machine 12 is not connected to the network 14 and (2) an on-line mode wherein the client machine 12 is connected to the network 14. In the off-line mode, the synchronization engine 28 performs only local synchronization operations, which may be triggered at predetermined time intervals. Alternatively, a local synchronization operation may be triggered from the PIM 22 or from the PDA 32. When operating in the on-line mode, the synchronization engine 28 performs both local and global synchronization operations. Again, both these local and global synchronization operations may be initiated by the client application 18 at regular, periodic intervals, unless a synchronization operation is initiated externally, for example, from a PIM 22 or a PDA 32.

In one embodiment of the present invention, the client application 18 may detect when the client machine 12 establishes a connection to the network 14, and trigger a global synchronization operation responsive to the establishment of the connection. According to a further embodiment of the present invention, a “manual” synchronization operation is offered, whereby a user of the client machine 12 will be prompted to initiate a local and/or global synchronization operation.

During a synchronization operation, the GUI 24 interacts with the client services module 26 and the synchronization engine 28 to provide a textual and graphic display of the progress of a synchronization operation. For example, the GUI 24 may provide textual descriptions of operations being performed by the synchronization engine 28, and may also provide a progress bar showing the percentage of the synchronization operation that is complete, or that remains to be completed.

As illustrated in FIG. 2, the client services module 26 includes the synchronization engine 28, a synchronization trader (application server) 52, an eXtensible Markup Language (XML) stack 53, and a collection of other synchronization traders 54 and 56. The trader 52 is an object that resides in the synchronization engine's primary thread and manages all communication and interaction between the client application 18 and the application server 40. Specifically, the synchronization engine 28 polls the application server 40 for new messages (e.g., notifications of other user's subscriptions or updates) and will furthermore inform the application server 40 of new recruitment requests. The synchronization engine 28 manages all timed events for the client application 18, including calls to initiate synchronization with the application server 40 and database 34, as well as synchronization operations with external entities such as the PIM 22 or the PDA 32. The synchronization engine 28 furthermore includes an interface for communicating with the GUI 24, so as to facilitate the display of messages received from the application server 40, and the display of information concerning a synchronization operation.

The synchronization trader 52 is an object that is created by the synchronization engine 28 upon request from the GUI 24, or at specified time intervals. The synchronization trader 52 is responsible for managing all synchronization between the local database 30, the application server 40 and associated remote database 34. The synchronization traders 54 and 56 are similarly responsible for managing synchronization between the local database 30 and external entities such as the PIM 22 and the PDA 32. Each of these synchronization sources is represented within the synchronization engine by a respective synchronization trader 54 or 56. Each synchronization trader handles all data retrieval and update operations to and from the external entity (or source) such as the application server 40, the PIM 22 or the PDA 32.

The interfacing of the synchronization engine 28 with the GUI 24, the local database 30, the application server 40 and the PIM 22 will now be described. The synchronization engine 28 provides the GUI 24 (or any other client) with information from the application server 40. A portion of the functionality exported from the synchronization engine 28 is provided by a Server Proxy Dynamic Link Library (DLL), while other functionality is provided by the synchronization traders 52, 54 or 56. Specifically, the synchronization engine 28 may implement an “automatic upgrade” function whereby the synchronization engine 28 automatically queries the application server 40 to determine whether an upgraded version of the client application 18 is available for upload to the client machine 12. The synchronization engine 28 further implements a “server session” functionality whereby a HTTP/TCP connection is established via the XML stack 53 (and the SSL stack 27) to the application server 40, and a number of methods are attempted to prompt the application server 40 to match contact information stored within local database 30 for which no copy exists within the server database 34. The client application 18 will then be notified of any matches that occur through messages from the application server 40 during a subsequent synchronization operation. Also included within the “server session” functionality is a contact match method, whereby personal information concerning the user of a specific client machine 12 may be published or communicated to further users.

The synchronization engine 28 may further implement a “message queue” functionality whereby pending messages held by the application server 40 are retrieved for processing and display by the client application 18, and a “recruiting” functionality.

As described above, the synchronization engine 28 manages all synchronization between external entities and the client application 18, and to this end obtains all updates from the local database 30 and from each of the synchronization traders 52, 54 and 56. If no conflicts arise, then both the external entity and the client application 18 will be updated with data from the other. The synchronization engine 28 will furthermore attempt to reconcile all conflicts that occur between data.

Each synchronization trader 52, 54 and 56 is responsible for exporting the database of the external entities that it represents as if it were compiled according to the scheme employed for the local database 30. Accordingly, each of the synchronization traders 52, 54 and 56 is responsible for performing a mapping operation between fields of the local database 30, and a database maintained, for example, by the PIM 22 or the PDA 32. Each synchronization trader 52, 54 and 56 accesses an interface for updating the synchronization trader 52, 54 or 56 regarding any non-standard or user-defined fields that may be created within the local database 30.

### Client-Server Protocol

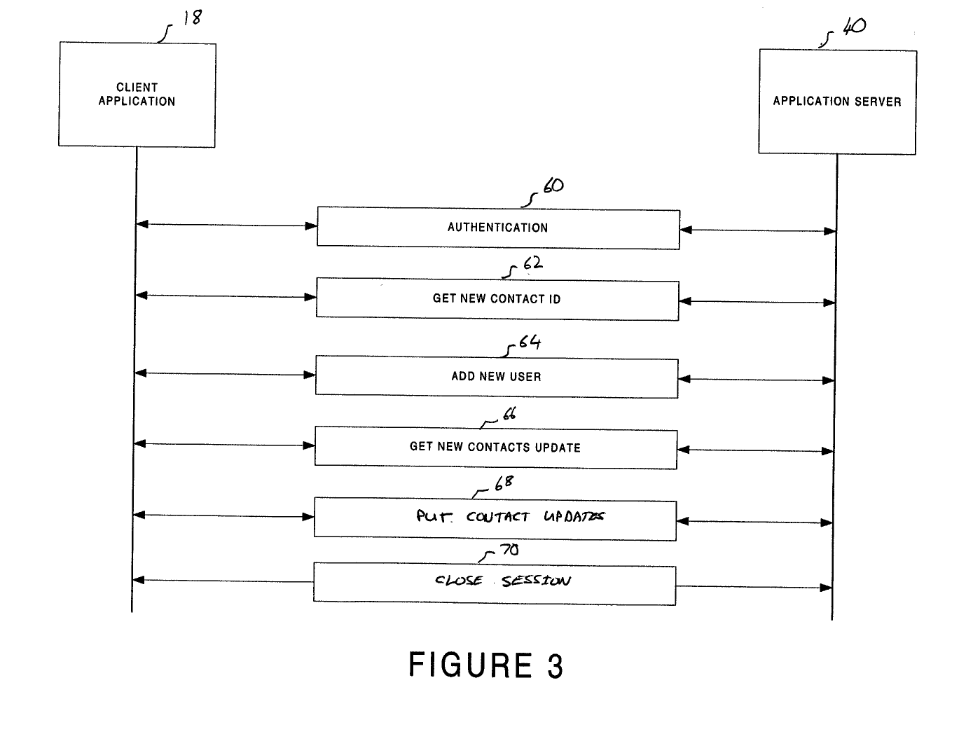

The communications that occur between the client application 18 and the application server 40 will now be described with reference to FIG. 3, which provides a diagrammatic representation of communications between these two entities.

The client application 18 encodes information to be sent to the application server 40 in eXtensible Markup Language (XML), and propagates an XML stream over HTTP to the application server 40. As described above, the HTTP communications may further be encapsulated utilizing SSL to provide a higher degree of security. The client application 18 then waits for the application server's HTTP response, which is also an XML stream. The XML stream received by the client application 18 delivers C++ objects.

The client application 18 may have the application server 40 execute or perform several “functions”. For example, the client application 18 may request the application server 40 authenticate a user. The instruction to the application server 40 to perform such functions requires that the client application 18 communicate several arguments to the application server 40. For example, when performing the above-mentioned authentication function, the client application 18 communicates a user name and a password to the application server 40. The application server 40 then returns a response, in the form of an authentication “cookie” in the case of a valid user authentication or an exception in the case of a failure.

FIG. 3 illustrates six exemplary functions that the client application 18 may request of the application server 40. Specifically, the client application may request an “authentication” function 60, a “get new contact identity” function 62, an “add new user” function 64, a “get new contacts updates” function 66, a “put contact updates” function 68 and a “close session” function 70. Each of the functions commences with a call from the client application 18 that includes the required arguments, and a response from the application server 40 that typically comprises an appropriate “cookie”.

The authentication function 60 requires the application server 40 to check and validate a user's login name and password, responsive to which the application server 40 returns an authentication cookie to the client application 18 if the user is authenticated or an exception if the user is not authenticated. The client application 18 may then utilize the cookie for other function calls to identify the relevant user.

The “get new contact identity” function 62 is called by the client application 18 when new personal information (e.g., contact information) is added to the local database 30 of the client application 18. Responsive to the appropriate call, the application server 40 generates a new identification number that is then communicated to the client application 18 in a response from the application server 40.

The “add new user” function 64 adds a new user to the application server 40, and specifically to the database 34.

The “get new contacts updates” function 66 retrieves a list of personal information update operations that have been performed with respect to personal information stored on the database 34 subsequent to a previous synchronization operation between the client application 18 and the application server 40. To this end, the client application 18 communicates a sequence identifier, to be described in further detail below, to the application server 40 that performs a look-up of sequence identify numbers subsequent to the received sequence identifier to identify data operations that have occurred since the previous synchronization operation. The application server 40 then responds by communicating messages detailing the updates that have occurred to the database 34 with respect to information to which the client application 18 has permissions.

The “put contact updates” function 68 is in effect the opposite of the “get new contacts updates” function 66, with the client application 18 communicating information concerning updates that have occurred with respect to the local database 30 to the application server 40. The application server 40 will then accordingly update the server database 34 with the received information, and propagate a response in the form of a sequence identify to the client application 18. It should be noted that a sequence identifier communicated from the client application 18 is for a sequence of operations with respect to the client application 18, whereas the sequence identifier communicated from the application server 40 to the client application 18 is with respect to a sequence of operations performed by the application server 40.

The “close session” function 70 essentially closes a session that has commenced with the performance of the “authentication” function 60, and accordingly disables or “kills” the authentication cookie maintained by the client application 18 for the current session.

### Databases and Data Structures

The present invention proposes allowing an owning user to store a master set of fields of personal information concerning the owning user, and then to designate different combinations and permutations of the fields of personal information as sub-sets of personal information. The present invention proposes allowing the owning user to publish a selected one or more of these sub-sets of personal information to a receiving user. The receiving user may then view the published sub-set as personal information, concerning the owning user, within a personal information repository (e.g., a PIM) of the receiving user. In one embodiment, the receiving user may populate, for example, an address book utilizing a sub-set of personal information published to the receiving user by the owning user. Each of the published sub-sets of personal information concerning the owning user may be viewed as a calling card of the owning user, which may in turn be classified as a personal card, a business card or other cards for distribution and publication to multiple receiving users.

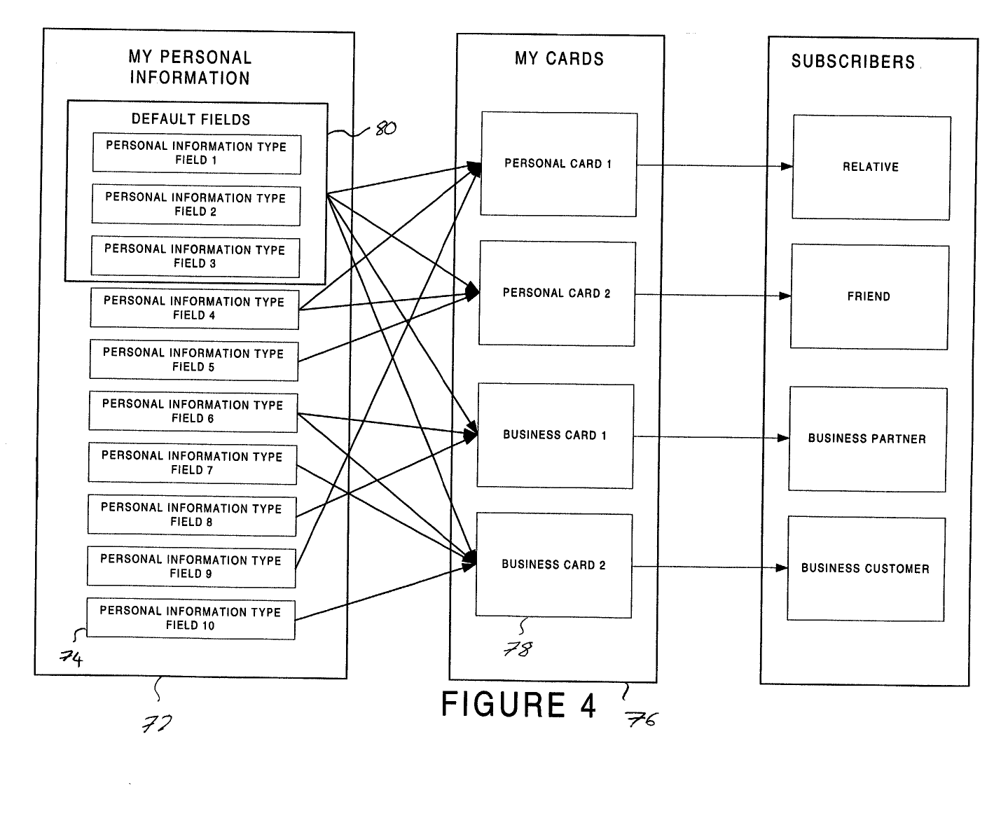

FIG. 4 is a high level, diagrammatic representation of the above described concept. Specifically, a master set 72 of personal information, comprising a number of fields 74, is defined, inputted and stored by an owning user. The input and storage of the master set 72 may, for example, be performed by a user via the client application 18, wherein the information is inputted via the GUI 24 and stored by the client services module 26 within the local database 30. The various fields 74 of personal information may include name, address, telephone, fax, e-mail, date, job title, work organization, medical, financial, family, interest, membership or any other personal information concerning the owning user.

The owning user may then record the designation of sub-sets of the information fields 74 as constituting respective virtual cards 78. By designating different sub-sets of fields 74 of the master set 72 as different cards, or collections of fields, the owning user can define a collection 76 of virtual cards 78. For example, the owning user may define a first personal card that includes only a sub-set of information fields 74 that the owning user is willing to communicate to family members. The personal virtual card 78 may thus be designated as a “family” card. The owning user may then designate a second sub-set of information fields 74 as a “friends” virtual card 78, the relevant sub-set of information fields 74 comprising information that the owning user wishes to publish to friends. The owning user may then define a “business” virtual card 78 that encompasses a sub-set of information fields 74 that are appropriate for communication to a business client, colleague or associate.

Having then defined the collection 76 of virtual cards 78, the owning user may record the selection of one or more cards for publication to a selected receiving user (or subscriber). For example, the owning user may select the “family” virtual card 78 for publication to one or more family members, whereas the “business” virtual card 78 may be selected for publication to a number of business customers of the owning user.

Following the selection of predetermined “virtual” cards for publication to the receiving users, the sub-sets of fields 74 of personal information of the owning user are then published to respective receiving users in accordance with the selection of the appropriate virtual card. The operation of publishing the information to the receiving users may occur in a number of ways. An underlying premise is that the receiving user is granted permission to access the sub-set of fields 74 of personal information of the owning user embodied within the virtual card selected for publication to the receiving user. The access, by the receiving user, responsive to the granting of permission of access may occur in a number of ways. First, in a web-based system, a single remote database, such as the server database 34, may be maintained, with the receiving user being granted permission to view the sub-set of information fields 74 contained within the published virtual card as part of the receiving user's address book. In this case, only a single copy of at least the sub-set of personal information fields needs to be maintained on the server database 34.

In an alternative embodiment, the personal information of the owning user embodied in the published virtual card 78 may be utilized to publish a dedicated database of personal information that is accessible and owned by the receiving user. The dedicated database of personal information owned by the receiving user may, in one embodiment, be populated partially, or completely, by sub-sets of personal information (e.g., virtual cards) to which the receiving user has been granted access. The dedicated database may be maintained on a remote server or, as is the case in the network environment 10 illustrated in FIG. 1, be maintained on a client machine 12 as the local database 30. In this case the local database 30 is required to be periodically synchronized with the information that is published to the relevant receiving user within the server database 34.

In yet a further embodiment of the present invention, the server database 34 may be excluded from the publication operation, and a sub-set of personal information of a publishing user, maintained on a local database 30 of a first client machine 12, may be accessed by, or published to, a client application 18 residing on a further client machine 12 to either populate a local database 30 maintained on that further client machine 12, or to be viewed by an application hosted on that further client machine 12. In this situation, the local database 30 on the client machine 12 of the publishing user would in effect be functioning as a server database.

In light of the above, it will be appreciated that the network environment 10 illustrated in FIG. 1, where local databases 30 maintained on different client machines 12 are synchronized via a server database 34 is merely one exemplary system by which the present invention may be implemented.

Referring again to the master set 72 of information fields 74 shown in FIG. 4, it will be noted that a specific sub-set of information fields 74 is designated as default fields 80. The publishing user may designate certain information fields 74 as default fields 80, in which case such default fields may automatically be included within sub-sets of information fields allocated as comprising virtual cards 78 of a particular type. This is indicated in FIG. 4, with the default fields 80 being included in each of the virtual cards 78 in the collection 76. A number of sets of default fields 80 may be defined for different virtual card types.

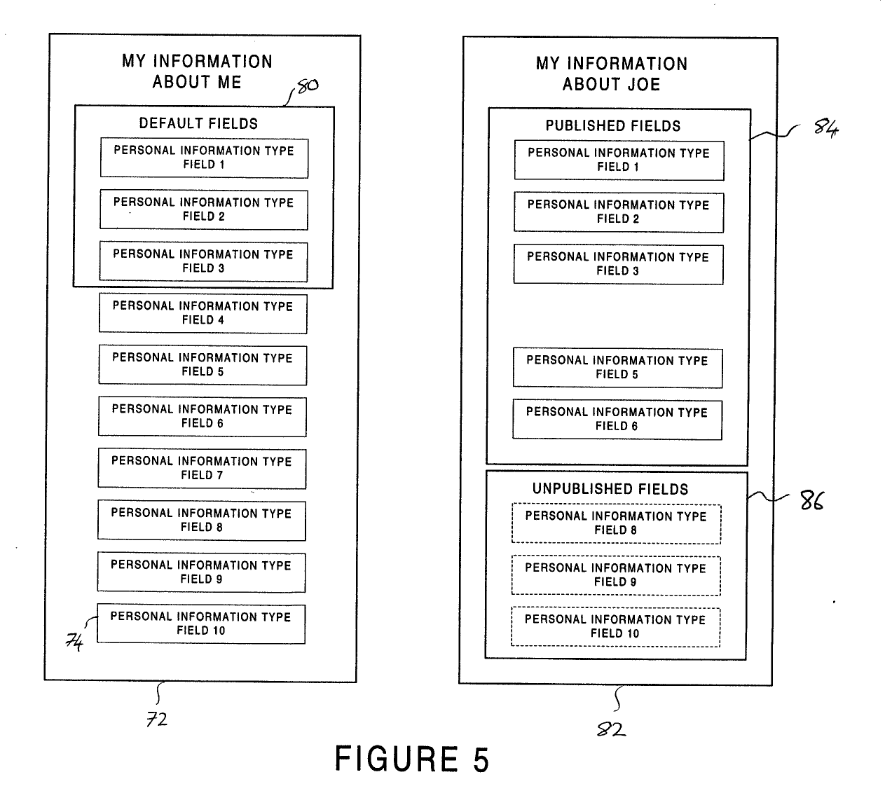

Dealing now with the exemplary embodiment of the present invention where a local database 30 of a client application 18 is maintained on a client machine 12, FIG. 5 provides an exemplary and high-level representation of information that may populate the local database 30. Specifically, the local database 30 may include the master set 72 of information fields 74 concerning the owner of the local database (e.g., the publishing or owning user) of which certain fields 74 may be designated as default fields 80. In addition to the master set 72 of information concerning the owner user, the local database 30 may contain personal information concerning a non-owning user (hereinafter referred to as a “contact”). This information is illustrated in FIG. 5 as a set of contact information 82. The contact information 82 within the local database 30 is shown to comprise both a sub-set of published fields 84 and a further sub-set of unpublished fields 86. The sub-set of published fields 84 may be populated by information communicated to the client application 18 by the contact, for example in the form of a virtual card 78 shown in FIG. 4. Accordingly, the contact, that is the publishing user with respect to the sub-set of published fields 84, generated the information that populates these published fields 84.

On the other hand, the sub-set of unpublished fields 86 is populated by information that may optionally be inputted into the local database 30 by the owner user. For example, the owner user may wish to record personal comments or information regarding the relevant contact. To this end, the owner user may wish to record a date at which the owner user last met the contact, and various circumstances of the meeting. This information would typically not be published by the relevant contact, but would be inputted and stored in the set of unpublished fields 86.

In summary, an exemplary local database 30 maintained by client application 18 and hosted on a client machine 12 may contain both owner user information (i.e., the master set 72 of information fields 74) and a number of sets of contact information 82. Each set of contact information 82 may in turn constitute a sub-set of published fields 84 and a further sub-set of unpublished fields 86.

Dealing now with the sub-set of published fields 84, in the case where the sub-set of published fields 84 is maintained in a local database 30, it is required that the information contained in these fields be periodically updated to conform to the information contained in corresponding fields of a master set 72 of personal information fields 74 maintained by the contact. This conforming operation is performed by periodically republishing the information from the source master set 72 to the sub-set of published fields 84.

In the exemplary embodiment of the present invention where local databases 30 are not maintained, and the sole information depository is the server database 34, the set of contact information 82 shown in FIG. 5 may be implemented as a permitted view, presented to a first user, of a selected sub-set of information fields 74 of a master set 72 of personal information of a second user. In this case, the second user is enabled to define the view of his or her information presented to the first user by assigning a specific and predefined virtual card 78 to the first user.

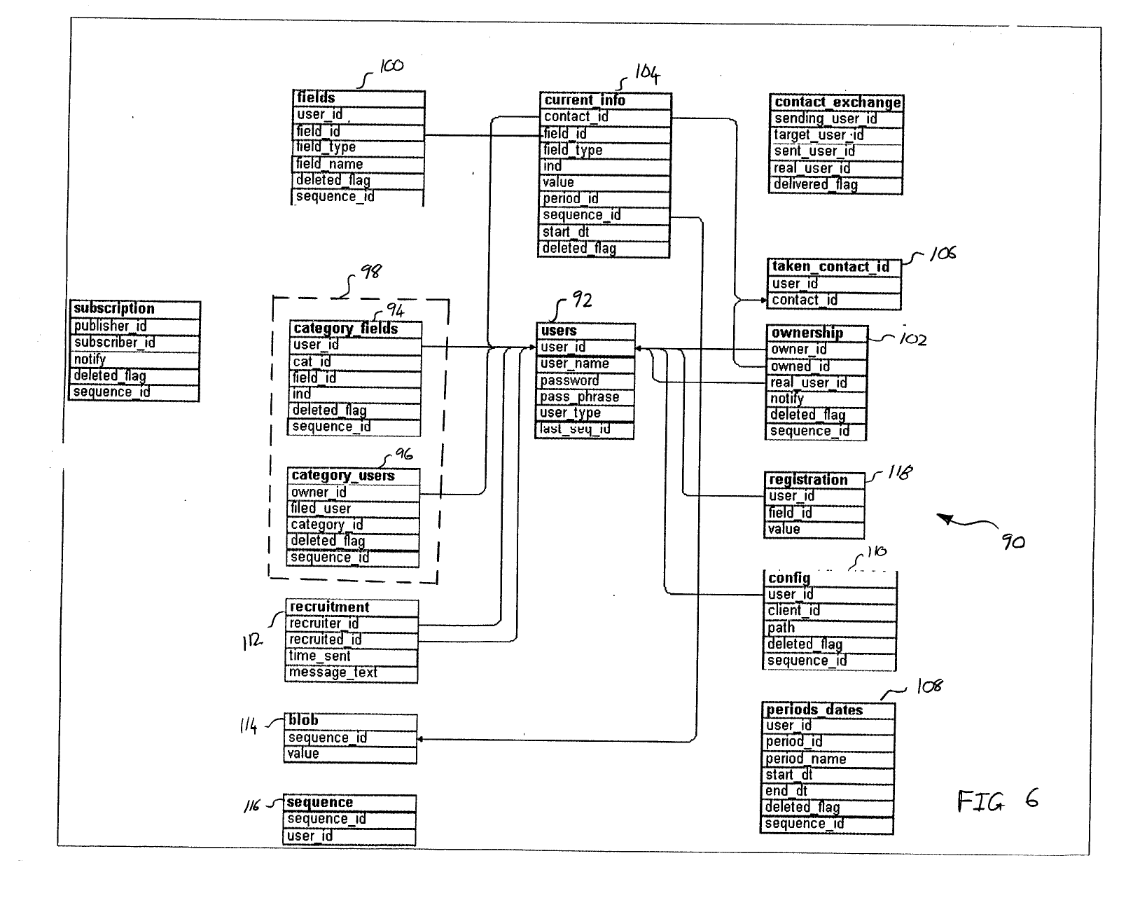

FIG. 6 is a diagrammatic representation of an exemplary database structure 90 that may be utilized to implement the server database 34 for an exemplary embodiment of the present invention. However, the database structure 90 may be implemented in either a server database 34 or a local database 30. In an exemplary embodiment of the present invention, the database structure 90 shown in FIG. 6 is implemented within the server database 34, whereas a simplified database structure (described below) is implemented within each local database 30.

The database structure 90 is shown to include a number of tables, each of which includes a number of fields that are linked or keyed so as to implement a relational database.

The database structure 90 includes a users table 92 that maintains a respective record for each registered user. Each registered user may operate as both a publishing and a receiving (or target) user. The users table 92 records a user identifier, name, password, user type and last sequence identifier for each user. The last sequence identifier stored for each user record indicates an operational sequence “peg” for an operation performed on a local database 30 with respect to the relevant user record.

The database structure 90 further includes a category_fields table 94 and a category_users table 96, the tables 94 and 96 together constituting a permission model 98, according to one exemplary embodiment of the present invention. The permission model 98 is utilized to define permission for particular fields of publishing user information to be published to a specific receiving user. The category_fields table 94 maps information fields, defined in a fields table 100, to specific categories, in a many-to-many mapping, so that a single category may include multiple fields, and a single field may be included within multiple categories. In one embodiment of the present invention, categories are user-defined, and each category constitutes a sub-set of fields of personal information that may selectively be published by a publishing user to a receiving user. As such, the categories may be viewed as one exemplary mechanism by which to define a virtual card 78, with multiple categories comprising a collection 76 of virtual cards 78. The category_fields table 94 includes a category identifier (cat_id), a field identifier (field_id), a user identifier (user_id) and a sequence identifier (sequence_id). The user identifier identifies the user (i.e., the publishing user) to which the relevant category-field mapping record belongs, while the sequence identifier again records an event sequence in which the creation of the relevant mapping occurred.

Each record within the category_users table 96 includes an owner identifier (owner_id) and a category identifier (category_id) that records ownership of a particular category (e.g., a virtual card) by a specific user (e.g., the publishing user) for which a record exists within the users table 92. The owner identifier (owner_id) within the category-users table 96 corresponds to a user identifier (user_id) within the users table 92, which in turn corresponds to an owner identifier (owner_id) within an ownership table 102.

Each record within the ownership table 102 further includes an owned identifier (owned_id) that may be utilized to record ownership by a receiving user of particular information regarding a publishing user. For example, where a receiving user supplements personal information regarding the publishing user within his or her local database, the owned identifier may be utilized to indicate such personal information concerning a first user that is “owned” by a second user.

A record within the ownership table 102 may further include a real user identifier (real_user_id) that indicates the identity of a first user that maintains information concerning that first user within the second user's local database 30. The real user identifier identifies information, concerning the “real user”, that is owned and maintained by the “real user” but that populates another user's local database 30.

A current_information table 104 stores actual values for each field (e.g., personal information field) for each user (that may comprise a contact) identified by the contact identifier (contact_id).

As mentioned above, a record is maintained within the users table 92 for each registered publishing and receiving user within the network environment 10. However, a specific user may, within a local database 30 or on the server database 34, maintain a set of personal information records for an entity (e.g., a person or company) that is not a registered user. In this case, where the entity for which a record is maintained and owned is not a registered user, the entity (i.e., the non-registered user) is classified as a “contact” as opposed to a user. It will be appreciated that a user ID does not exist for the relevant contact. The taken_contact_id table 106 contains a record for each such contact, and maps a specific contact identifier (contact_id) for the relevant contact to a user identifier (user_id) to indicate ownership and origination of the relevant contact information.

It will furthermore be noted that an owned identifier (owned_id) within the ownership table 102 may correspond to a contact identifier (contact_id) within the taken_contact_id table 106.

A current_information table 104 stores and maintains actual values for personal information fields for all contacts (some of which are registered users) whose information is stored within the database structure 90. Accordingly, each record within the current—information table 104 includes a contact identifier (contact_id), a field identifier (field_id) and a field type (field_type). The contact identifier (contact_id) is shown to correspond to an owner identifier (owner_id) in the category_users table 96 in the case where the record in the table 104 is for information that is published, and therefore owned, by a registered user for which a record exists within the users table 92. On the other hand, where the record within the table 104 includes information that is not owned, or published, by a registered user (e.g., contact information regarding an entity (contact or user) that has been inputted into an address book and not in fact published to the address book), the contact identifier (contact_id) correspond to a contact identifier within the table 106, which records a user, other than the entity to which the information pertains as an owner of the relevant contact identifier. It will also be noted that the contact identifier (contact_id) in the table 106 in this case corresponds to the owner identifier (owned_id) within the ownership table 102.

In summary, the contact identifier (contact_id) for each record within the current_information table 104 corresponds either to an owner identifier (owner_id) within the table 106 in the case where the information is published by an entity to which that information pertains, or corresponds to a contact identifier (contact_id) within the taken_contact_id table 106 in the case where the information is not published by an entity to which the information pertains and that is manually included within a users contact information pertaining to the entity by the relevant user.

The field identifier (field_id) for each record within the current_information table 104 identifies a particular field corresponding to the field type identified within the same record. For example, the field type may comprise a telephone number, and the field identifier may identify the record as storing a home, work, or mobile telephone number.

A record within the current_information table 104 also includes a value field, which stores an actual numeric, or alphanumeric, value for the relevant contact, identified by the contact identifier, for the field identified by the field identifier. For example, the value field would include an actual home telephone number.

A sequence identifier is also included within each record of the current_information table 104 to identify an activity within an activity sequence by which the relevant record was updated or generated.

A period identifier (period_id) included within each record of the current_information table 104 provides a key to a record within periods dates table 108 that is populated with records indicating time periods during which a specific record within the current_information table 104 is valid or extant. To this end, each record within the current_information table 104 includes a period identifier (period_id) to facilitate keying of a record to a record within the periods dates table 108 that includes a period name (period name), a start date (start_dt), an end date (end_dt) and a sequence identifier (sequence_id). Consider, for example, the hypothesized situation where a particular user usually based in Calif. spends a week in London, UK, and wishes to have his or her contact information updated for that period to reflect a London address and telephone number. In this situation, the user may identify a record within the current_information table 104 as being valid for the duration of his or her stay in London by indicating appropriate start and end dates within a record within the periods_dates table 108 that is keyed to a record within the current_information table 104 that stores personal information (e.g., a work telephone number) that will be valid for the duration of the stay of the user in London between the start and end dates. Further, where the record within the current_information table 104 is for a contact (as opposed for a user), an owner of that contact information may pre-specify that an alternative set of personal contact information be valid and displayed for a particular period. In effect, by linking records within the current_information table 104 to records within the periods_dates table 108, a user may maintain different sets of personal information (e.g., contact information) that are published to receiving users over predetermined, specified time periods to reflect changes in the personal circumstances of the relevant publishing user. The period name may be utilized to attach a convenient and easily identified label to such time intervals. For example, a user could label a particular period as “visit to London”, and attach the relevant time specification to a specific sub-set of personal information fields that is published to other receiving users.

The database structure 90 further includes a configuration table 110 that is populated by records indicating configuration information pertaining to, for example, the GUI 24 of a client application 18 hosted on a client machine 12. To this end, each record within the configuration table 110 includes a client identifier (client_id) that identifies a particular client application 18 to which the configuration parameters are applicable.

A record within the configuration table 110 may furthermore be keyed to a user identifier (user_id) thus making the configuration information stored in the relevant configuration record applicable to all client applications 18 for a particular user identified by the identifier. In this way, a user preference (e.g., a GUI display specification) specified via a particular client application 18 of a particular user can be uniformly applied across all client applications 18 associated with the relevant user and via which the user accesses information stored in the database structure 90. For example, a particular user may specify a particular configuration preference from a client application 18 executing on a computer system in a work environment. In this case, the configuration specification will also be communicated to a client application 18 that executes on a computer system operating within a home environment of the same user. In this way, configuration preferences are applied to all client applications 18 via which a specific user accesses the database structure 90. The values indicating the configuration specification may be stored in the shown “path field”.

The present invention also contemplates that users, for which user records exist within the users table 92, may attempt to recruit non-users to become registered with a personal information publication system supported by the database structure 90. To this end, the database structure 90 includes a recruitment table 112 that maintains a record of recruitment messages communicated from registered users to non-users. For example, a non-user may constitute a contact within a users address book, and the client application 18 may, in combination with the application server 40, provide a mechanism via which a user may invite a non-user to become a registered participant within the personal information publishing system. The recruitment table 112 maintains a record for each such “invitations” communicated from a user to a non-user, and attributes a recruiter identifier (recruiter_id) to the sender of the invitation, a recruited identifier (recruited_id) for each non-user who is successfully recruited and becomes registered as a user, a time record indicating the time at which the invitation was sent, and a record of the text of the invitation. A record is only created in the recruitment table 112 upon successful recruiting of a non-user as a user of the personal information publication system.

A blob table 114 provides a supplement to the current_information table 104, and is utilized to store values for specific personal information fields where the values comprises anything beyond one line of continuous alphanumeric information. For example, where the stored personal information includes a carriage return, constitutes video, graphic or audio information, or other non-alphanumeric information, a value representative of this information may be stored within an appropriate record within the blob table 114. To this end, the GUI 24 may support the display of a graphic image (e.g., a digital photograph in the JPEG format) of a contact that may be published to a receiving user. For example the GUI 24 may display this digital photograph in a manner so as to associate the digital photograph with other personal information pertaining to the publishing user on a display provided to the receiving user. In this case, a value that represents the digital photograph would be stored within an appropriate record within the blob table 114. Further, a particular publishing user may wish to publish a digitized audio recording of the correct pronunciation of his or her name. In this case, the client application 18, and specifically the GUI 24, may present a graphic icon or text that is user-selectable to invoke play back of the recorded digital audio pronunciation of the name published to the receiving user from the publishing user. In this case, a record within the blob table 114 would, in the value field, store an appropriate digitized representation of the audio recording. It is further envisaged that the blob table 114 may store records including values indicative of logos, or any other graphic, video or audio information that a particular may wish to include within his or her personal information to be published to receiving users.

Finally, the database structure 90 includes a sequence table 116 that maps each sequence identifier (sequence_id) to a specific user identifier (user_id), and a registration table 118 that records registration information for each registered user within a personal information publishing system. Specifically, a record for each registered user will be created within the registration table 118 upon the valid registration of the user, and specific registration information may be stored within a value field of each such registration record.

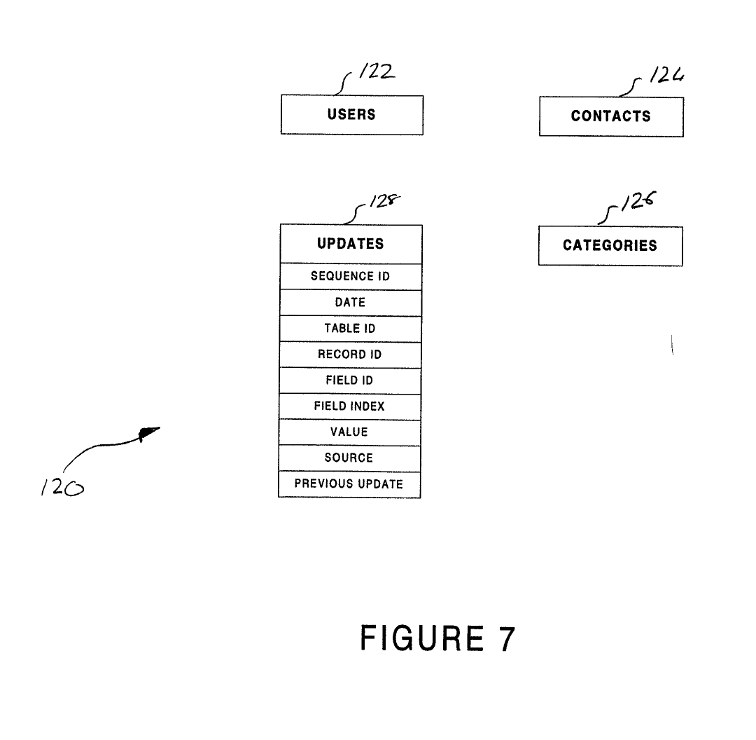

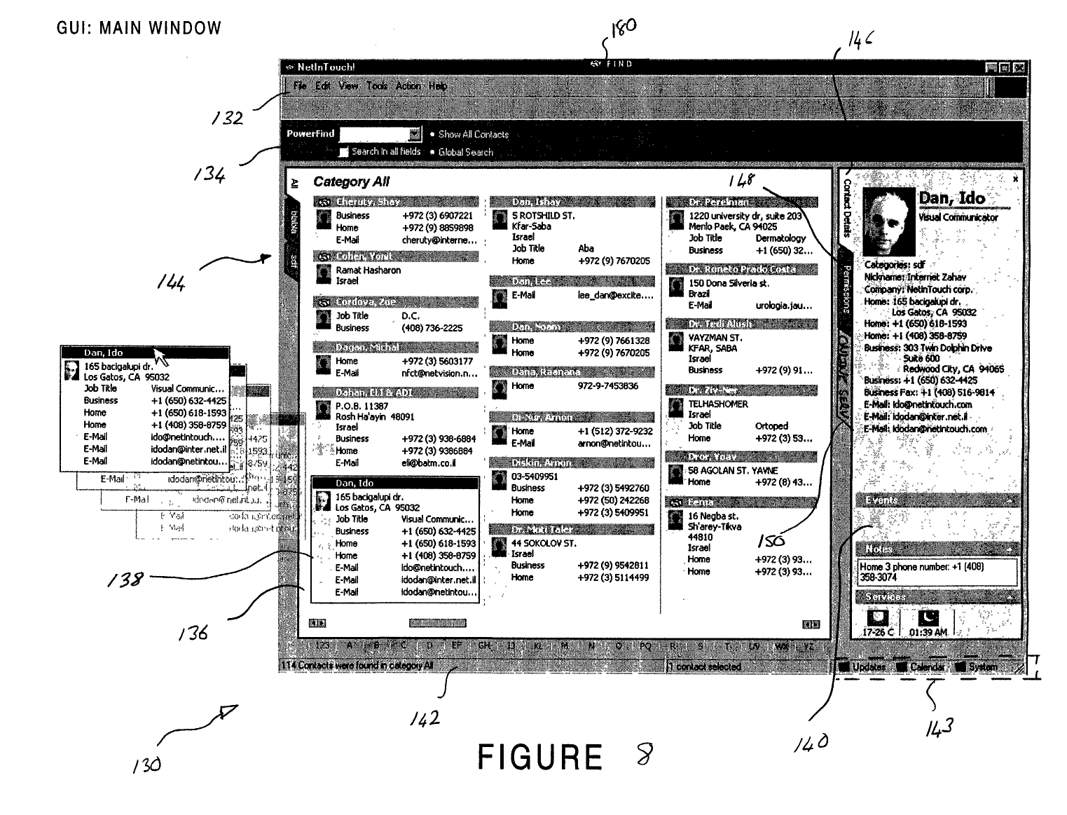

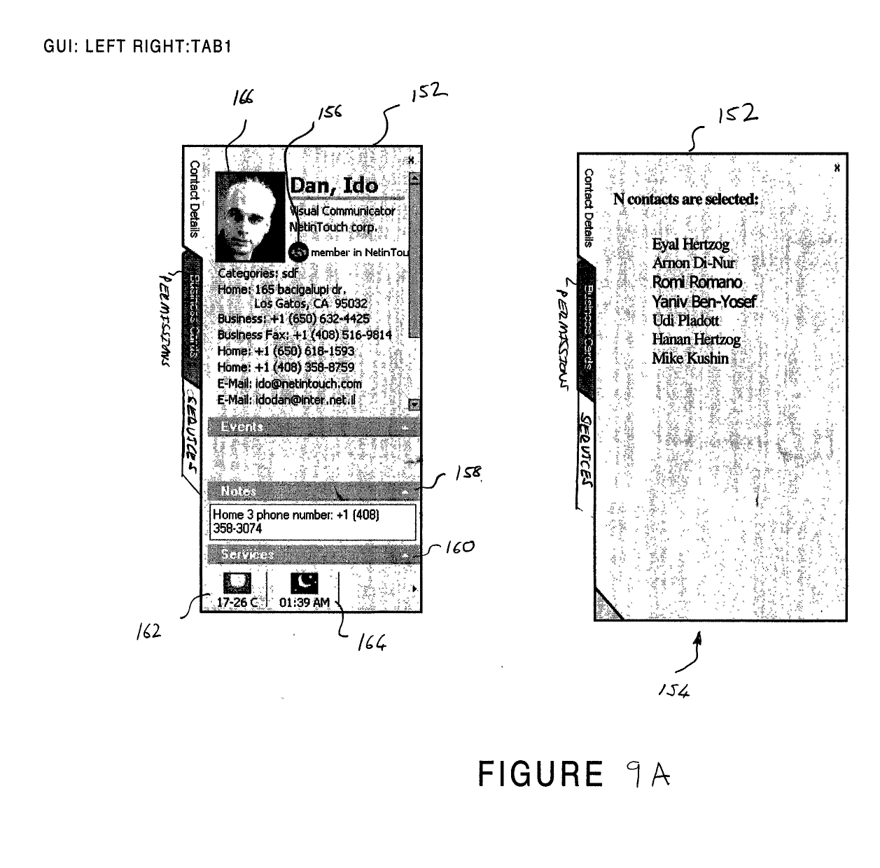

As mentioned above, the database structure 90 illustrated in FIG. 6 may be utilized to implement either a local database 30 or a server database 34. In an exemplary embodiment, it is envisaged that the database structure 90 be implemented within a server database 34, and a simplified version of this database be mirrored by each local database 30. To this end, FIG. 7 illustrates an exemplary local database structure 120 comprising a number of information entities that may either constitute tables or, where the database constitutes an object database, information objects. Viewing the information entities as objects, the local database structure 120 includes a users object 122 that may store a sub-set of information stored in the users table 92 of the database structure 90. Specifically, the sub-set of stored information may comprise records for only those users that have elected to publish information to the receiving user that owns the local database 30 within which the structure 120 is implemented. The local database structure 120 may further include a contacts object 124 that corresponds substantially to the current_information table 104 maintained within the server database 34. The contacts object 124 stores both published user information, and locally inputted contact information for entities whose records are maintained and viewed by a receiving user utilizing a local client application 18. Again, the records stored within the contacts object 124 may constitute only a sub-set of the records stored within the current_information table 104, the sub-set being determined by permissions granted by publishing users to the receiving user, and also by information inputted locally by the receiving user.

The local database structure 120 may further include a categories object 126 that stores information corresponding approximately to information stored within the category_fields table 94 and the category_users table 96 within the database structure 90. Accordingly, the categories object 126 provides a local and user-specific version of the permission model 98 implemented by the category_fields table 94 and the category_users table 96 within the database structure 90.

The local database structure 120 finally includes an updates object 128 that maintains a record for each update to any of the tables 122-126, and accordingly stores a sequence identifier, data, table identifier, record identifier, field identifier, field index, value, source and previous update information for each update that occurs within a local database 30. The previous update information stored within each record within the updates object 128 provides a pointer to a previous record that details a previous update. In this way, the client services module 26 of the client application 18 is able conveniently to trace a sequence (or history) of updates to a particular field of a particular record. This sequence, or history, of updates may then be communicated to the GUI 24 for display to a user.

### User Interface and Methodology

In order to understand the methodologies implemented by a client application 18, and an application server 40, according to an exemplary embodiment, it is useful to provide a description of the displays generated by the GUI 24 of the client application 18 via which a user, in a publishing role, may input personal information concerning himself or herself, or information concerning a contact, and via which a user, in a publishing role, may elect to publish selected personal information, in the form of a virtual card 78, to receiving users. Furthermore, the GUI 24 facilitates the display to a user, within a receiving role, of personal information concerning other users that is published to the user in the receiving role. Further, the GUI 24 presents information concerning contacts to a user that the relevant user may have inputted him or herself.

FIG. 8 is a screen print showing a main window 130, according to an exemplary embodiment of the present invention, that may be generated by the GUI 24. While the UIs are described below as being Windows® UIs, it will be appreciated that such UIs may comprise markup language documents generated by a web server.

The main window 130 includes a tool bar 132, a “power find” panel 134 via which a user may conduct a search of contact information contained within the local database 30, a browser panel 136 that displays personal information pertaining to contacts in the form of “contact cards” 138, a right panel 140, and a status bar 142.

Turning first to the “power find” panel 134, by inputting text into the text window provided in the “power find” panel 134, a user is able to search the local database 30. Specifically, the GUI 24 communicates an inputted search string to a thread-based fetch mechanism implemented in the client services module 26 that then returns search results to the GUI 24. The search results are displayed within the browser panel 136, and are refreshed every 0.5 seconds after each character input into the text window in the “power find” panel 134. In this way, the number of contacts located by the search is dynamically varied as the user inputs further characters into the search window. For example, after entering the leading letter “c”, all contacts having a last name beginning with “c” will be displayed within the browser panel 136. Shortly after entering a subsequent “o” letter, only the contacts having a last name beginning with the letters “co” will be displayed following the 0.5 second dynamic refresh. Furthermore, the number of contacts located by current search parameters are displayed in the status bar 142.

The “power find” panel 134 further provides a “global search” option that is use-selectable to provide a more powerful searching tool, utilizing which the user may search multiple fields using respective criteria for each of those information fields.

The browser panel 136, as mentioned above, displays a virtual card for each contact of a selected category, or as located by a specific search query entered into the “power find” panel 134. A user may categorize various contacts for display purposes. For example, a user may designate a certain contact as being either a private contact, a business contact or as belonging to one or multiple other user-defined category. A tab, such as any one of those shown at 144, is then created for each user-defined category, and a user may conveniently view contact information for each respective category by performing a selection operation (e.g., utilizing a cursor control device such as a mouse) on an appropriate tab for the relevant category. In the screen shot shown in FIG. 8, the contacts in category “ALL” are shown in the browser panel 136.

Each contact card 138 shows a common design, and the information displayed in the contact cards within the browser panel 136 is not editable via the browser panel 136. In an exemplary embodiment, three default views for contact cards are provided. A first “photo” view provides merely a name caption and photograph, a “regular” view provides the photo and three to four customizable and user specifiable information fields, and a “full” view displays all the relevant contact's personal information fields stored within the local database 30.

As illustrated in FIG. 8, the GUI 24 provides the capability for a user to perform a “drag-and-drop” operation with respect to a contact card 138. Specifically, by selecting, and then operating a cursor control device, a user can drag a contact information card to place the contact information card in a further category (e.g., by dragging the contact card to an appropriate tab 144, and then “releasing” the card) or to create a copy of the selected contact card as a virtual “memo” on a user interface desktop presented on a computer system. When placing a particular contact card in a further category utilizing a drag-and-drop operation, the user may furthermore specify whether the relevant contact card is to be moved to the further category, or to be copied to that further category.

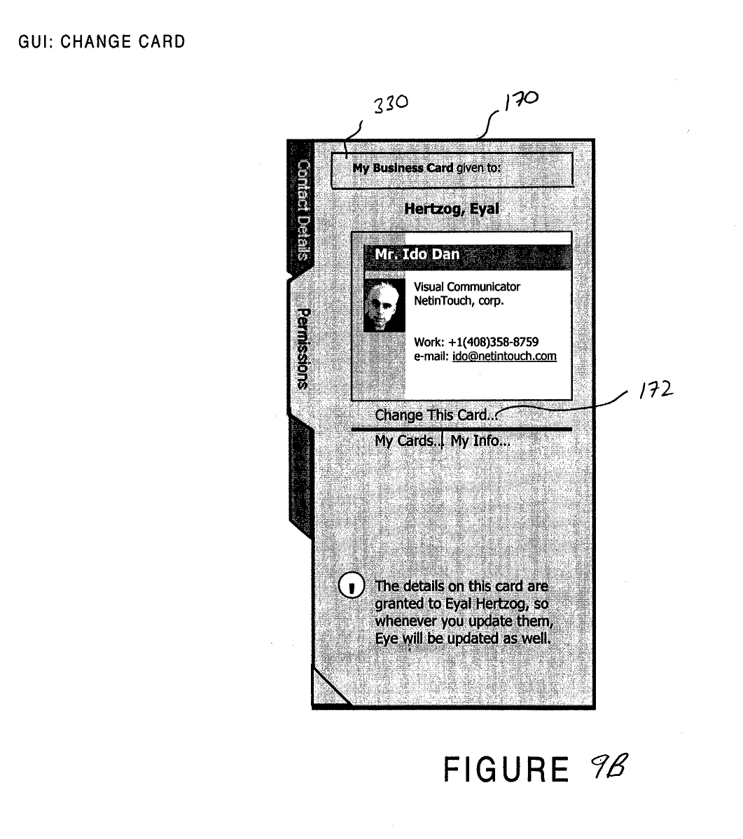

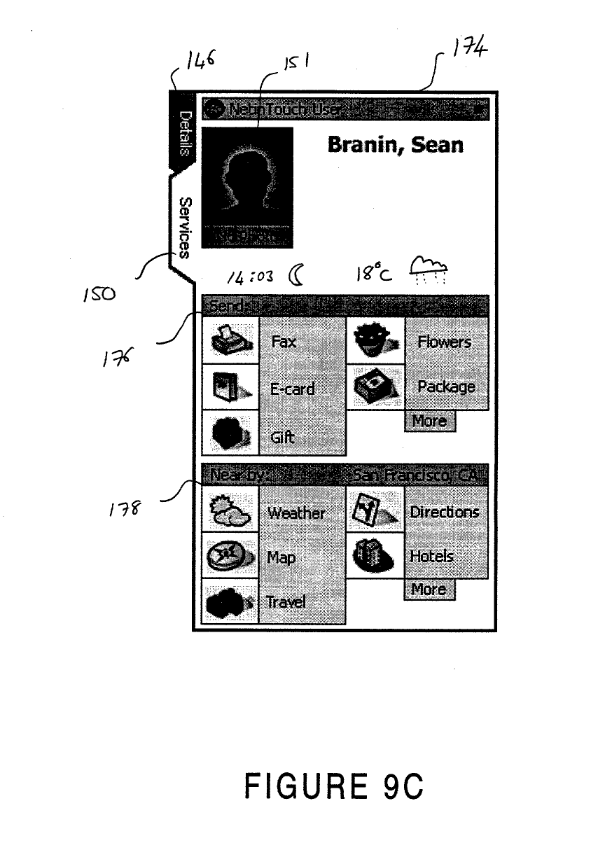

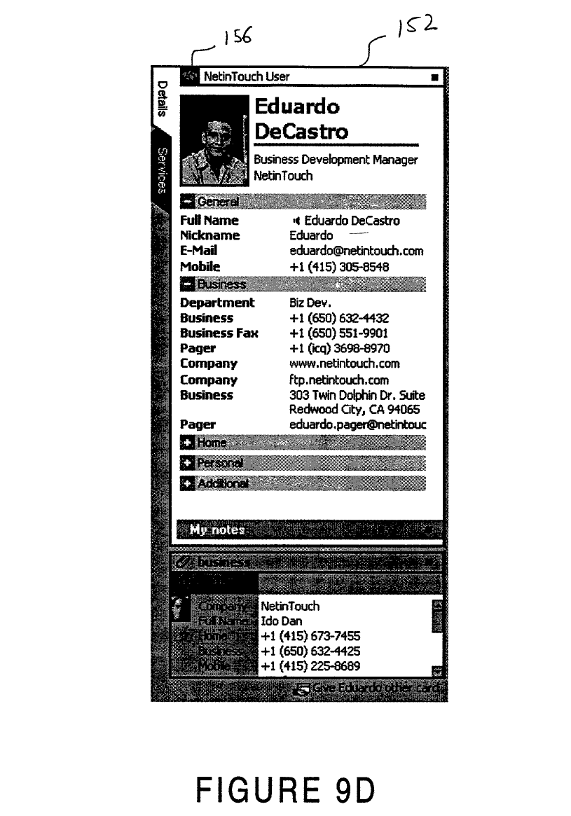

Turning now to the right panel 140, this panel 140 includes a tab-set consisting of a “contact details” tab 146 associated with a contact details panel 152, a “permissions” tab 148 associated with a “permissions” panel 170 and an “on-line services” tab 150 associated with an on-line services panel 174. Dealing first with the contact details panel 152, an example of which is shown displayed in FIG. 8, when the contact details tab 146 is active (i.e., in the foreground), the associated contact details panel 152 displays information concerning a contact, or contacts, selected in the browser panel 136. In the case where only a single contact card 138 is selected in the browser panel 136, then a full set of information for the selected contact is shown. An example of the presentation of information where only one contact is selected is shown at in FIG. 9A. It will be noted that the personal information displayed in the contact details panel as shown in FIG. 9A includes an icon 156 that indicates whether the relevant contact is a registered user within the personal information publication system, and accordingly a user for which a record exists within the users table 92 of the database structure 90 illustrated in FIG. 6. Presentation of the icon 156 indicates that at least certain personal information displayed within the contact details panel 152 is published and maintained by the relevant contact via the personal information publication system.

The contact details panel 152 further includes a “notes” section 158, within which the relevant user may record a personal note, or other information regarding the relevant contact.

Further, the contact details panel 152 includes a “services” section 160 that displays information concerning the relevant contact that may be retrieved via the network 14, (e.g., the Internet) from an on-line publishing source. For example, the client services module 26 may issue a request to any one of a number of resources available on the Internet to obtain real-time, or near real-time, information pertaining to the relevant contact. For example, the client services module 26 may access the local database 30 to determine the residential city of the contact, and then formulate and propagate a request to an appropriate Internet service to retrieve weather and local time information for the relevant residential city. This information is then displayed, together with appropriate icons, as weather information 162 and local time information 164 within the services section 160 of the contact details panel 152. Other real-time, near real-time, or on-line information, that may be presented within the contact details panel 152 and retrieved based on personal information within the local database 30 regarding a particular contact, includes stock price information regarding an organization for which the contact works, “white page” information regarding an employer of the contract, a map indicating a home or work location for the contact, or any other on-line information that may be readily obtained utilizing personal information stored for the contact. On-line information as retrieved may then be displayed, together with the appropriate icons and graphics, within the services section 160 of the contact details panel 152.

Finally, the contact details panel 152 also displays a digital image 166, for example stored in the blob table 114 within the database structure 90, for the relevant contact.

In the event that two or more contacts are selected within the browser panel 136, then the contact details panel 152 assumes the form shown at 154 in FIG. 9A, where the full names of the selected contacts are displayed as a list.

User-selection of the “permissions” tab 148 results in the permissions panel 170 shown in FIG. 9B being displayed in the right panel 140. Specifically, the permissions panel 170 indicates the virtual card 78 of the relevant user that has been issued or published to the relevant contact. A particular user, in a publishing role, may, in one exemplary embodiment of the present invention, publish a single virtual card (e.g., a business card) to a single contact. In an alternative embodiment, a publishing user may issue multiple virtual cards 78 to a single contact card in which case the various sub-sets of personal information embodied in each of these virtual business cards 78 may be combined to present a unified sub-set of the personal information of the publishing user to the receiving user (i.e., the contact).

The permissions panel 170 further includes a “change this card” button 172, that is user selectable to change the virtual card 78 assigned to the relevant contact. Further details regarding the changing of a virtual card published to the contact is provided below.

As discussed above with reference to FIG. 9A, one embodiment of the contact details panel 152 may include a services section 160 that displays dynamic, or service, information pertaining to a relevant contact. This dynamic or service information may be retrieved via a network. FIG. 9C shows an exemplary embodiment of the services panel 174 that is displayed responsive to user selection of the services tab 150 within the right panel 140. In one embodiment, the services panel 174 provides a broader range of dynamic and service information pertaining to the user than displayed in the services section 160 of the contact details panel 152.

As illustrated, the services panel may again display a digital photograph 151 of the relevant user, as well as real-time, or near-real-time, information pertaining to the relevant contact in the form of time and weather information at a location (e.g., a recorded residential or business address) for the contact.

The services panel 174 also includes a “send” section 176, that presents user-selectable icons and text that are selectable to invoke services that allow a user to send, for example, a fax, electronic greeting card or an e-mail to the relevant contact. Specifically, user selection of a “fax” option may invoke a faxing application on a hosting computer system. The client application 18 may in this case also communicate appropriate contact information (e.g., a name and fax number) to the fax application so that the user is not required manually to enter this information. Similarly, user selection of an “e-mail” option may invoke an e-mail application and insert the relevant contact's e-mail address into a message template.

The send section 176 also includes user-selectable options to send, for example, a gift, flowers or a package to the relevant contact. In one embodiment, each of these sending options is user-selectable to invoke network communications to a service provider for the respective service. For example, user selection of a “flowers” option may invoke a browser application, and direct that browser application to a predetermined flower vendor by, for example, communicating a query (e.g., a URL) to a flower vendor web site. The URL may further include an identifier that identifies a referring particular entity (e.g., a developer or vendor of the client application 18) to the flower vendor. In terms of a referral agreement, the referring entity may be eligible for a referral fee for establishing communications with the flower vendor, or may be eligible for a commission on any transaction concluded by the user as a result of the referral via the client application 18. In a further embodiment, the flower vendor may, for example, make a lump sum, or periodic, payments to the developer or supplier of the client application 18 to be designated as a vendor that is presented to the user responsive to user-selection of the “flowers” option. It is of course envisaged that multiple vendors may be associated with each product or a service option presented within the send section 176.

In the present example, the URL that is communicated to the flower vendor may also include personal information (e.g., name and address information) regarding the relevant contact whose information is being displayed within the services panel 174. The flower vendor may in this case, in response to the URL, generate a web page that facilitates a transaction between the user and the flower vendor. For example, a web page that allows a user to select one of multiple flower arrangements for delivery to the contact may be generated. This web page may be pre-populated with the personal information included within the query communicated to the flower vendor responsive to user selection of the “flowers” option. In this way, convenient ordering of an item or services facilitated by the automatic inclusion of personal information within a query that is submitted to an online vendor, this personal information may be automatically extracted from a database maintained by a personal information management application, and automatically embodied in a request to the relevant vendor. It will of course be appreciated that the query do not comprise a URL. For example, the query may perform according to any of a number of known protocols, and may be embodied in a GET request issued in terms of the HTTP protocol. Further, a query, embodying personal information, may be communicated to any vendor of services of products.

A “near by” section 178 again presents a number of user-selectable options that a user may select to obtain information, for example via a network, pertaining to a relevant contact whose information is displayed within the services panel 174. As shown, weather, map, travel directions and hotel options are presented in the exemplary “near by” section 178. In one embodiment, each of these options is user-selectable to invoke an Internet browser (e.g., the Internet Explorer, developed by Microsoft Corporation of Redmond, Wash.), and to communicate a URL of one or more preferred service providers to the browser or directly to a web site operated by a relevant service provider. Further, the client application 18 may provide relevant location information to a preferred service provider, so that the response from the service provider to the user selection of an appropriate option displays information pertinent to the contact. For example, user selection of “map” option may result in the communication of a URL to the browser, which in turn communicates the URL to a map web site (e.g., Mapquest). In this case, the URL may embody address information regarding the relevant contact, as well as an identifier identifying a developer or supplier of the client application 18. The map web site may, responsive to the URL, provide a graphical map representation to the browser, visually indicating the location of an address for the relevant contact. Further, the identifier for the developer or supplier of the client application 18 allows the map web site to identify the request as having originated via the client application 18, and accordingly to monitor a number of referrals from the client application 18, or to make appropriate payments to the developer or supplier of the client application 18.

Similarly, weather, travel, direction and hotel options may be selected to communicate information (e.g., in the form of URLs) to appropriate web-based services, via the browser.

In one embodiment, three cases of “post-click” behavior are contemplated. In a first case, it may be that a user has not selected a specific contact, or the personal information for the contact does not include the required information to invoke a selected service. For example, the client application 18 may not have access to address information for the relevant contact. In this case, a dialog block may be presented communicating this fact to the user.

In a second case, the appropriate information is available, and the client application 18 is able to compose a query containing, for example, contact information for a relevant user that can be communicated to an appropriate service provider.

In a third case, more than one field of the pertinent contact information may be available. For example, the client application 18 may have access to both a business and a residential address for the relevant contact. In this case, a menu or dialog block is presented to the user that allows the user to select an appropriate field (e.g., a residential address as opposed to a business address) to be included within a query. This menu or dialog block is presented prior to opening of the browser.

FIG. 9C illustrates an alternative embodiment of the contact details panel 152 shown in FIG. 9A. In this embodiment, the contact details panel 152 includes three scrollable sections, namely a “contact fields” section, a “my notes” section and a “my attached card” section. The “contact field” section includes a number of headers that can be expanded or contracted to display appropriate information.

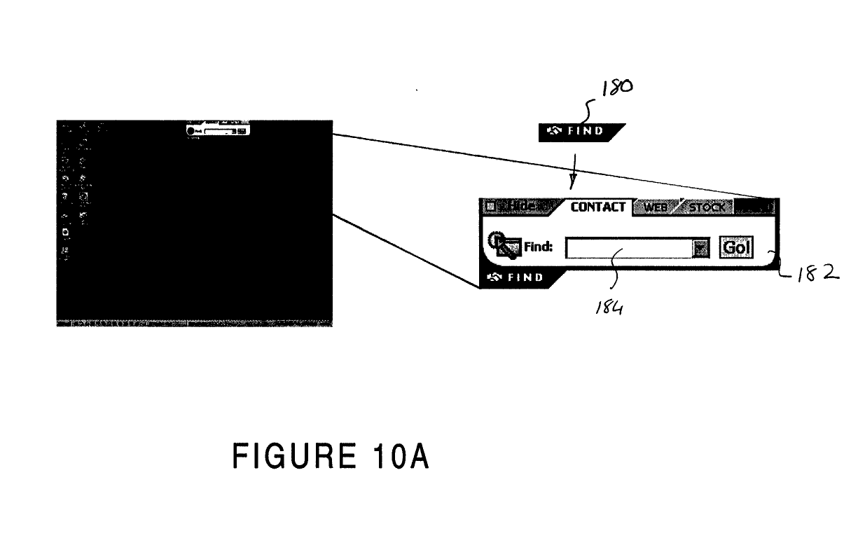

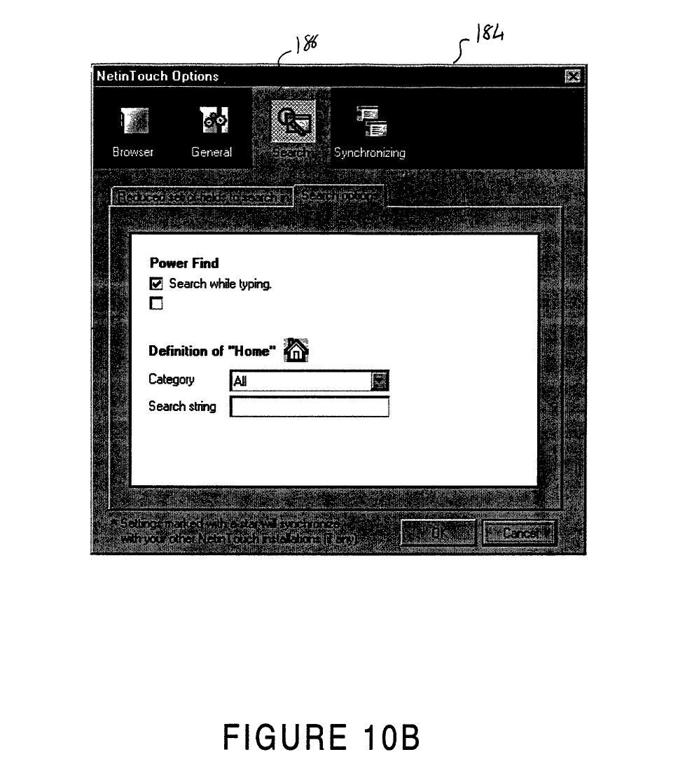

The “power find” panel 134, which is embodied within the main window 130, is described above with reference to FIG. 8. FIG. 10A illustrates an alternative persistent window 182 that may be persistently accessible via a Windows® GUI to provide convenient access to a “power find” text block, without requiring opening of the main window 130. Specifically, in one embodiment, a “find” tab 180 is persistently displayed adjacent an edge of the Windows® GUI. User selection of the “find” tab 180 drops down the persistent window 182 that includes a text input field 184 into which a user may input such text. The persistent window 182 also includes contact, web and stock tabs in order to allow a user to direct a search that utilizes text inputted into the field 184. Specifically, a search performed where the contact tab is active may perform a search of contact information maintained by the client application 18. A search conducted when the web tab is active may direct the search text to an appropriate Internet search engine. A search initiated when the stock tab is active may direct an appropriate query to a financial web site.

FIG. 10B illustrates an options interface that may be utilized to specify search options by selection of a search tab 186. Specifically, the search options allow a user to specify that a search of contact information be performed while search text is being inputted to enable the number of contacts located by the search to be dynamically varied as a user inputs characters into a search window, as described above with reference to FIG. 8.

The search options also allow a user to specify that a reduced set of fields (e.g., only name fields) be searched.

### Methodology—Definition of a Virtual Card

FIG. 11 is a flow chart illustrating a method 200, according to an exemplary embodiment of the present invention, of storing a set of fields of personal information, and recording user-selection of a sub-set of these fields as a first information category to be published as a virtual business card 78.

The method 200 commences at block 202 with the receipt of user information to populate a set 72 of personal information fields 74 such as those, for example, illustrated in FIG. 4. This information may be manually inputted from a user-input device coupled to the client machine 12, or may be inputted via a synchronization operation with an external information source, such as the PIM 22 or the PDA 32 via the synchronization engine 28.

For manual input of the personal information for the publishing user, FIG. 12 illustrates an exemplary “my information” dialog block 216, which shows the various information fields that may be populated, via the. dialog block 216, with personal information. It should be noted that the personal information may include a digital photograph 218, which a user may import from a storage location on the client machine 12 or from a remote location via the network 14. Furthermore, the local database 30 may store a number of digital photographs of the publishing user, which can be cycled through by user selection of the buttons 220.

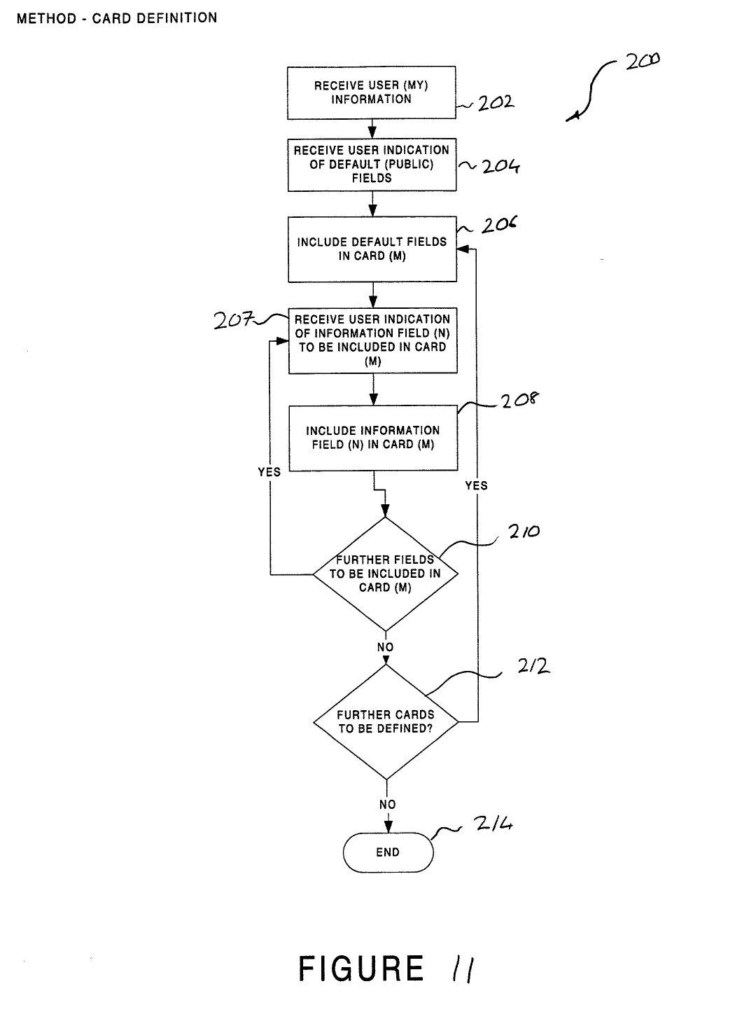

The “my information” dialog block 216 further provides a “name recording” user-selectable function 222, whereby a user may invoke a sound recording object to store a digitized audio recording of, merely for example, a preferred pronunciation of the publishing users name or other information. FIG. 13 illustrates a sound object window 224 that may be generated to facilitate recording of the digitized audio recording to be included within the personal information of the publishing user. This information may then again be stored, by the client services module 26, within an appropriate record in the blob table 114, maintained within the database structure 90.

Returning to the “my information” dialog block 216 shown in FIG. 12, both address and e-mail input windows 226 and 228 have a number of tabs associated therewith, whereby the user can label sets of address information, or an e-mail address as pertaining to either a home, personal, or business environment. Furthermore, for an e-mail address, one of a number of e-mail addresses may be selected as a currently active e-mail address. By inputting information into the various input fields illustrated in the “my information” dialog block 216, the publishing user may thus at least partially populate a set 72 of personal information fields 74.

At block 204 of the method 200 illustrated in FIG. 11, a user may optionally indicate a sub-set of the personal information fields 74 as comprising default fields 80. In an alternative embodiment, the default fields 80 may be predefined within the client application 18 (e.g., the first and last name information fields), and thus accordingly be incorporated within all virtual cards 78 constructed by the publishing user.

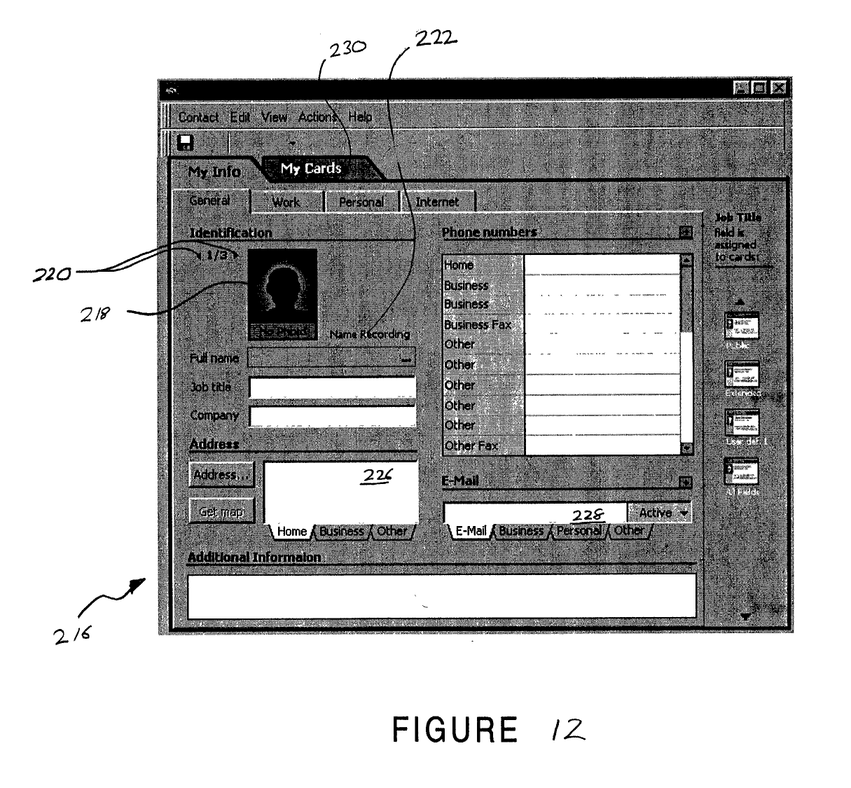

At block 206, the construction of a specific virtual card 78 begins with the user selection of a “my cards” tab 230, shown in FIG. 14, to invoke a “my cards” window 232. At block 206, the default personal information fields 80 are automatically included within any card that the publishing user chooses to construct. Referring now specifically to the “my cards” window 232, a scrollable column 234 of thumbnail graphic representations 236 of all virtual cards 78 that have been defined for the publishing user is shown, below which the publishing user is presented with a number of user-selectable buttons presenting the option of renaming a virtual card, generating a new virtual card, removing a virtual card, and editing “my information”. The thumbnail graphic representation 236 of a selected virtual card 78 is highlighted, and a full size graphic representation 238 of the selected virtual card 78 is displayed alongside the selected thumbnail graphic representation 236. Adjacent the full size graphic representation 238, a scrollable column 240 display all fields 74 of personal information for user selection and inclusion within the selected business card for which the full size graphic representation 238 is displayed. It should be noted that information fields 74 within the column 240 that have been included within the selected virtual card 78 are visually distinguished (e.g., by implementing a different color background for such fields) so as to provide the user with a convenient manner of identifying which information has and has not been included within the virtual card 78.

FIG. 14 also shows the window 232 as including text 241 that is user selectable to display a window (not shown) that displays a list of contacts that the relevant user has designated as being able to “see” the relevant virtual card.

Returning again to the flow chart shown in FIG. 11, at block 207, the client application 18, and specifically the GUI 24, receives a user indication of an information field to be included within the subject virtual card 78. For example, this user indication may be received by detecting a user selection operation (e.g., a double click operation) performed with respect to a particular information field displayed within the scrollable column 240 within the “my cards” window 232.

At block 208, following reception of the user indication, the relevant information field is included within the selected virtual business card 78. As described above with reference to FIG. 4, the inclusion of a selected user information field 74 within a virtual user card 78 may be implemented by creating a record within the category_fields table 94 that maps the relevant field 74, for the relevant user, to a specific category, wherein the category constitutes the selected virtual card 78.

At decision block 210, a determination is made as to whether further personal information fields are to be included within the selected card. This determination may be made, merely for example, by detecting whether the user de-activates the “my cards” window 232, indicating that the construction of a selected virtual card 78 has ended. If a further selection of a field within the scrolling column 240 is detected, the method 200 loops back from decision block 210 to block 207. Alternatively, if a user operation is detected which indicates that no further fields are to be included within the relevant virtual card 78, the method 200 proceeds to decision block 212, where a determination is made as to whether further virtual cards are to be defined. For example, user selection of the “new card” button shown in the “my cards” window 23, indicates that the user wishes to define further cards, in which case the method 200 loops back from the decision block 212 to the block 206. Alternatively, a closing, or deactivation, of the “my cards” window 232 indicates that no further cards are to be defined, and the method 200 then terminates at block 214.

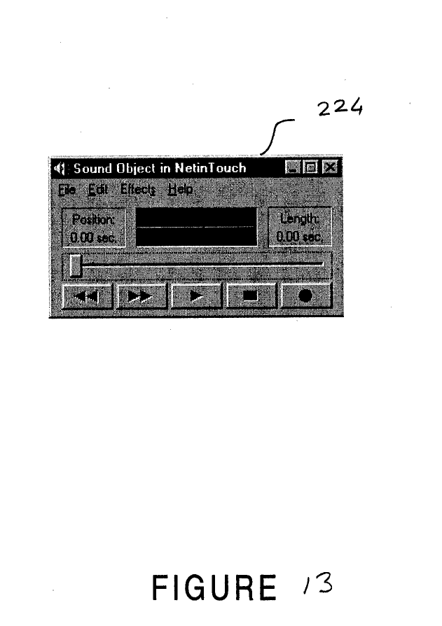

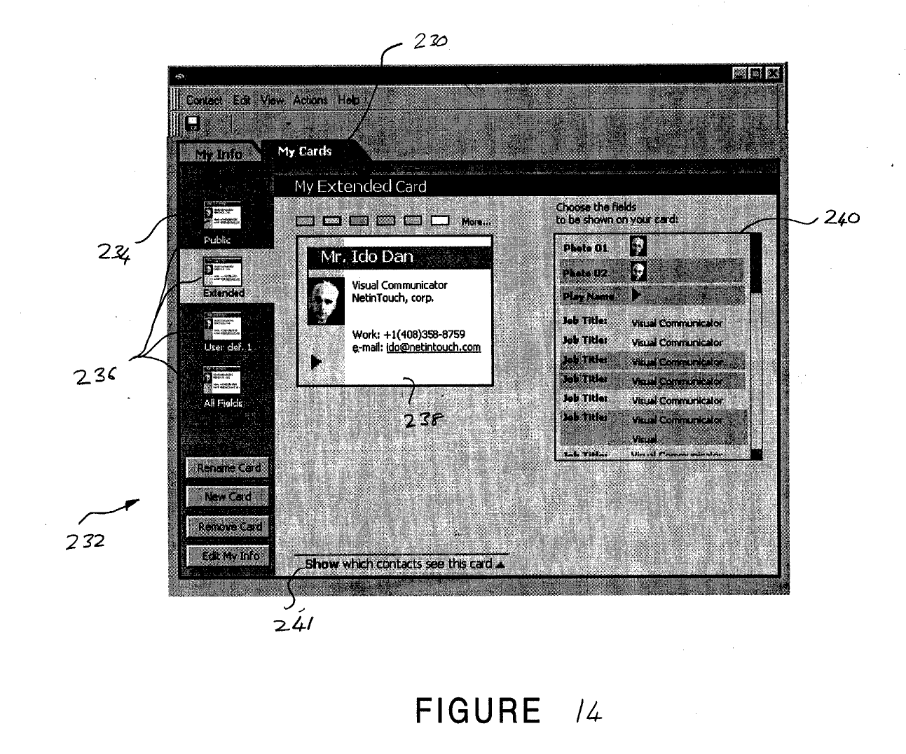

FIGS. 15A-15C illustrate three screen prints, according to exemplary embodiments of the present invention, of windows presented by the GUI 24 to supplement and enhance the user information input, and card creation processes described above with reference to FIG. 11. Specifically, the screen prints shown in FIGS. 15A-15C may be viewed as implementing three privacy control features. Following user selection of a personal information field to be included within a selected virtual card 78 or following input or update of contents of a personal information field, at block 207 of the method 200 illustrated in FIG. 11, a prompt window 242 is invoked, which again provides a scrollable column 244 of thumbnail graphic representations 236 of virtual cards 78 created by the publishing user and a user-selectable check block 246 adjacent each of these thumbnail graphic representations 236. The user is further prompted in a text panel 248 to indicate in which of the virtual cards 78, identified by the thumbnail graphic representations 236, the selected information field is to be included. By the user selecting a check block 246 associated with each of the virtual cards 78, a user can indicate that the selected information field is to be included in one, or multiple, virtual cards 78. Following the selection of all virtual cards 78 in which the selected information field is to be included, the user may then select an “OK” button 252 to confirm the indicated selection.

FIG. 15B shows a template window 254 that may be generated by the GUI 24 upon user selection of the “new card” button presented within the “my cards” window 232 illustrated in FIG. 14. The prompt window 242 displays respective thumbnail graphic representations associated with a number of card templates. Specifically, each card template may comprise a sub-set of default fields 80 that may be used as the basis for constructing a specific virtual card. The creation of a card template corresponds to block 204 of the method 200 illustrated in FIG. 11, where the client application 18 receives user indication of default (e.g., public) fields 80 that constitute, merely for example, a “public” card template, for which an exemplary graphic representation 236 is shown in FIG. 15B.

Having selected (e.g., by performing a double-click operation on any one of the thumbnail graphic representations 236 displayed within the template window 254) a template, a bibliographic window 256, such as that shown in FIG. 15C, is presented. The bibliographic window 256 includes a “card name” field into which a user can input a new name for the relevant card, as well as a description field into which a user can input description information regarding the newly created card.

### Methodology—Card Publication

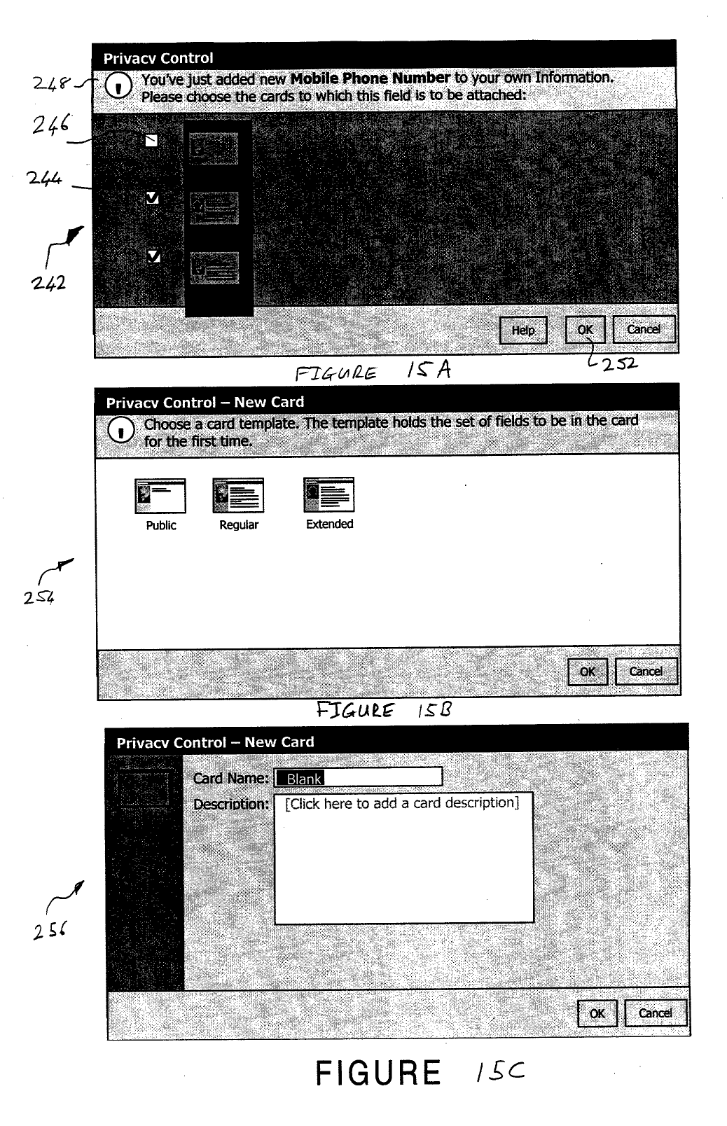

FIG. 16 is a flow chart illustrating a method 300, according to an exemplary embodiment of the present invention, of publishing a selection of personal information from a publishing user to a receiving user. In one exemplary embodiment, the selection of personal information constitutes a sub-set of personal information fields 74 that are defined as a virtual card 78.

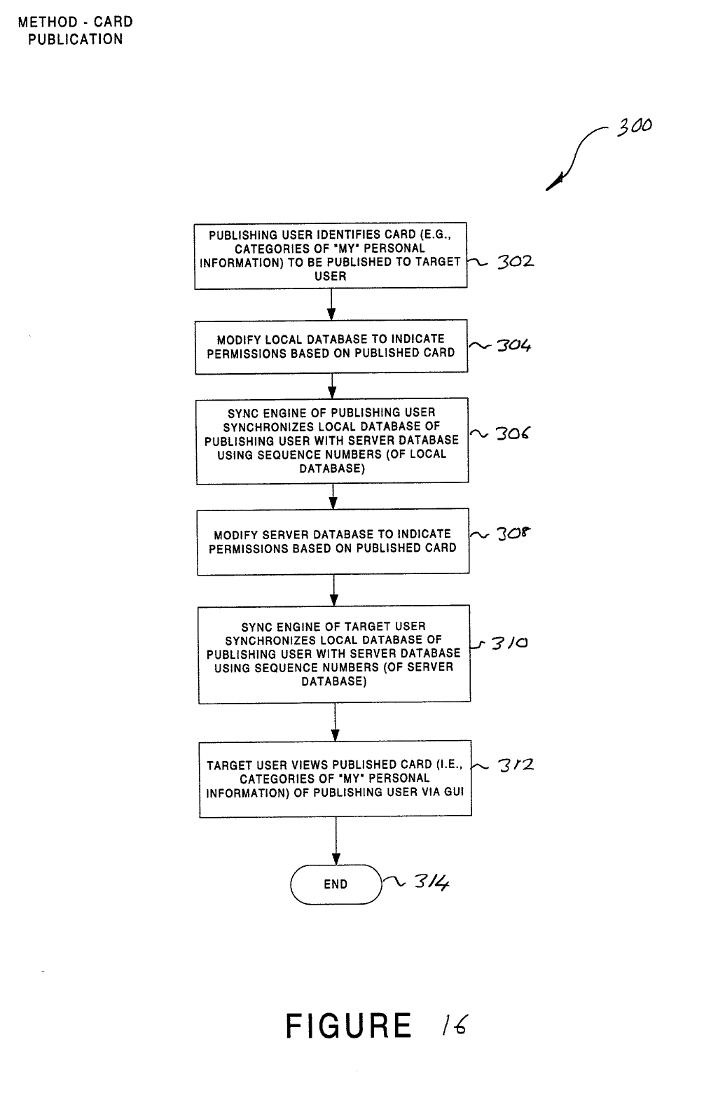

The method 300 commences at block 302 with the publishing user providing an indication, via the client application 18, of a sub-set of personal information concerning the publishing user (e.g., a virtual card 78) to be published to a target user. Referring back to FIG. 10, upon user selection of the “permissions” tab 148 within the right panel 140, the permissions panel 170 is displayed, and indicates a virtual card 78 that has been assigned to a contact selected in the browser panel 136. In the event that no virtual card 78 has yet been assigned to the selected contact, the publishing user will be prompted within the permissions panel 170 to select one of a number of defined virtual cards for publication to the selected contact.

Where a specific virtual card 78 has already been selected for publication to the selected contact, the publishing user may change the published virtual card by user selection of the “change this card” button 172 within the permissions panel 170. More specifically, referring to FIG. 17, user selection of the “change this card” button 172 causes a “change card” window 320 illustrated in FIG. 17 to be displayed on a display device associated with the client machine 12 of the publishing user. The “change card” window 320 is shown to include a thumbnail window 322, within which thumbnail graphic representations 236 for each virtual card 78 (i.e., sub-set of personal information) defined by the publishing user or displayed. A user is then able to select one of these virtual cards 78 for publication to the selected contact by, for example, performing a double-click operation with respect to an appropriate thumbnail graphic representation 236.

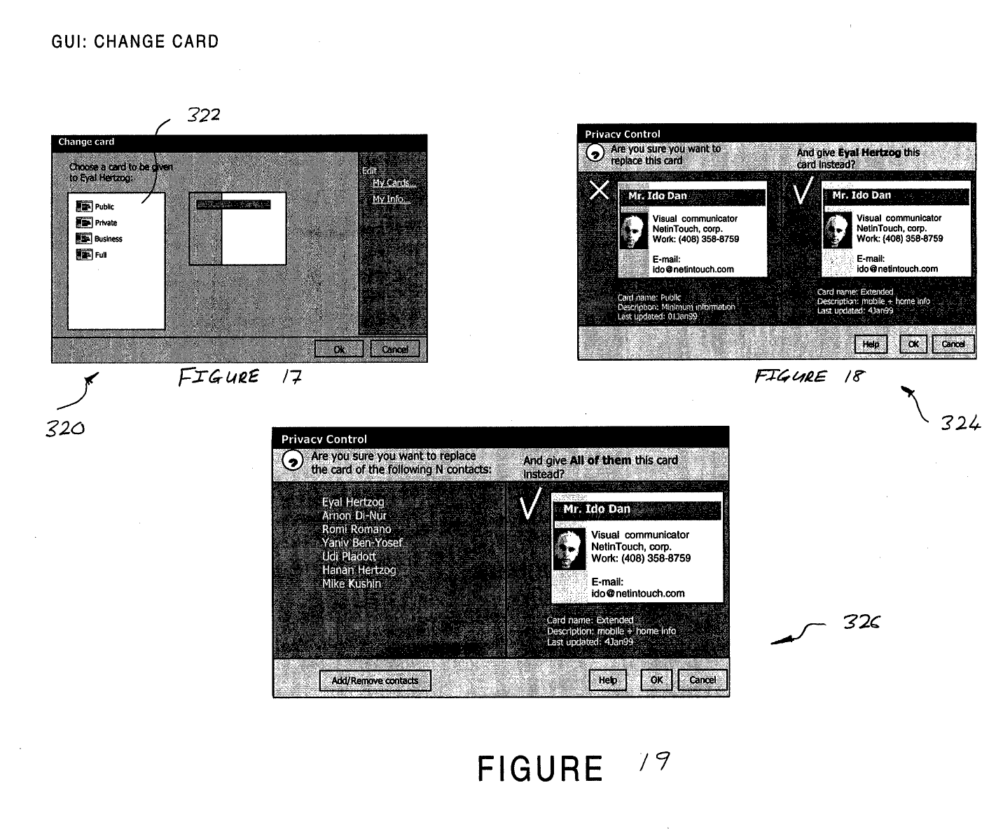

FIG. 18 shows a confirmation window 324, wherein the publishing user is presented with full-size graphic representations of both the virtual card 78 to be replaced and the replacement virtual card, and is prompted to confirm that the replacement card is indeed to be published to the receiving user. FIG. 19 shows an alternative confirmation window 326 that is presented to the publishing user where a card change is being performed with respect to multiple selected contacts. For the confirmation window 326, a list of the names of the contacts to which the change is to be applied is displayed in a left side of the window 326, in lieu of the card being replaced, while a full graphic representation of the replacement card is again displayed in the right side of the window 326.

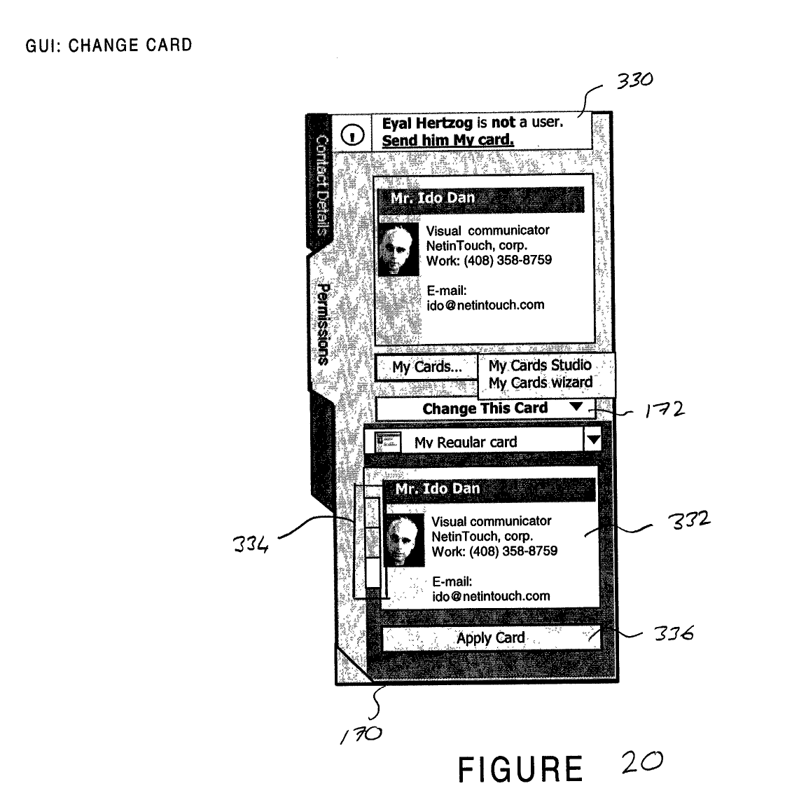

FIG. 20 is a screen print of the permissions panel 170 display panel for a situation in which a contact selected in the browser panel 136 is not a user, or registered participant, within a personal information publication system according to the invention, (e.g., no record exists for the relevant contact within the users table 92 or the database structure 90). In this case, the publishing user is notified within a contact status field 330 that the selected contact is not a registered user, or participant, within the personal information publication system. In this case, the publishing user will then be prompted to initiate an invitation process. Where the contact is a registered user, the contact status field 330 will indicate the name of the virtual card 78 that is being published to the relevant contact. In the case where the relevant contact is not a registered user, but a virtual card 78 has been presented to the selected contact for acceptance, the contact status field 330 will report that the name of the virtual card 78 that has been sent to the selected contact, while indicating that the relevant contact is not as yet a user.

FIG. 20 further illustrates an alternative display mechanism by which the GUI 24 may facilitate user selection of a particular virtual card 78 to be published to a user. Following user selection of the “change this card” button 172, a small pane 332 is opened that holds graphic representations of virtual cards for preview. A color tab-set 334 is furthermore displayed to facilitate convenient browsing and selection of a virtual card that should replace a virtual card shown in the upper half of the permissions panel 170. User-selection of an “apply card” button 336 may then optionally cause the confirmation dialog block shown in FIG. 18 to be displayed.

Returning now to the flow chart for the method 300 shown in FIG. 16, following identification of a virtual card 78 to be published to a target user, the method 300 proceeds to block 304, where the local database 30 is modified, or updated, to indicate publishing permissions that have been granted by the publishing user to the receiving user. Specifically, as indicated above, a virtual card 78 embodies a sub-set of personal information fields 74 for which the publishing user has granted publishing permissions to the receiving user. The local database 30 is then updated to reflect this publication. Specifically, the categories table 126 of the local database structure 120 shown in FIG. 7 may be updated to indicate that a specific category, corresponding to the relevant virtual card 78, may be published to the receiving user.

At block 306, the synchronization engine 28 of the client application 18 of the publishing user synchronizes the local database 30 with the server database 34 utilizing an appropriate sequence number scheme employed by the local database 30. Specifically, the application server 40 will communicate a sequence number of the last activity with respect to the local database 30 of which the server database 34 was aware. The synchronization engine 28 will then communicate records for all activity occurrences with respect to the local database 30 that have sequence numbers greater than the sequence number communicated from the application server 40 to the client application 18.

At block 308, the server database 34 is modified to indicate the permissions granted by the publishing user to the receiving user based on the relevant virtual card 78. More specifically, the permission model 98 is updated to indicate the granted permissions. Again, where the virtual card 78 corresponds to a specific category, which in turn is comprised by a sub-set of personal information fields 74 regarding the publishing user, the category_users table 96 is updated to indicate that a specific receiving user has been granted permission to access, or receive, personal information regarding the publishing user that is included within the relevant category.

At block 310, a synchronization engine 28 of the client application 18 for the receiving user performs a synchronization operation between the server database 34 and the local database 30. Specifically, the synchronization engine 28 will communicate to the application server 40 a sequence number, employed by a sequencing scheme of the server database 34, that indicates the last activity with respect to the server database 34 of which the synchronization engine 28, and accordingly the local database 30, is aware. Following receipt of the sequence number at the application server 40 at the synchronization engine 28, the application server 40 will access the server database 34, and communicate records (e.g., from the current_information table 104) for all updates that have occurred to the server database 34 subsequent to the received sequence number, and for which the relevant receiving user has been granted permission within the permission model 98, and specifically the category_users table 96. Accordingly, the local database 30 of the receiving user will be then updated with the personal information of the publishing user.

At block 312, the receiving user is then able to view the relevant virtual card 78 that was published to the receiving user by the publishing user. The viewing of the relevant virtual card 78 is facilitated by the GUI 24 of the client application 18 in the manner described above with reference to FIG. 8. Specifically, the published virtual card 78 will appear within the browser panel 136 of the main window 130 presented to the receiving user by the GUI 24.

The method 300 then ends at block 314.

The method 300 is advantageous in that, when a publishing user updates his or her personal information (e.g., utilizing the “my information” dialog block 216 shown in FIG. 12), the updated information stored in the publishing users local database 30 is synchronized with a copy of the personal information concerning the publishing user maintained within the server database 34. The server database 34 is then in turn at least partially synchronized with a local database 30 of a receiving user, and in this way the local database 30 of the receiving user is populated with current and updated information.

It will again be appreciated that, while the publication of information from a local database 30 of a publishing user to the local database 30 of a receiving user is performed via the server database 34, the present invention further contemplates that personal information could be published directly from the local database 30 of the publishing user to the local database 30 of the receiving user. In a further embodiment of the present invention, the local databases 30 could be done away with, and both the publishing and receiving user could be presented with different views, based on granted permissions, of information stored on a single database, such as the server database 34.

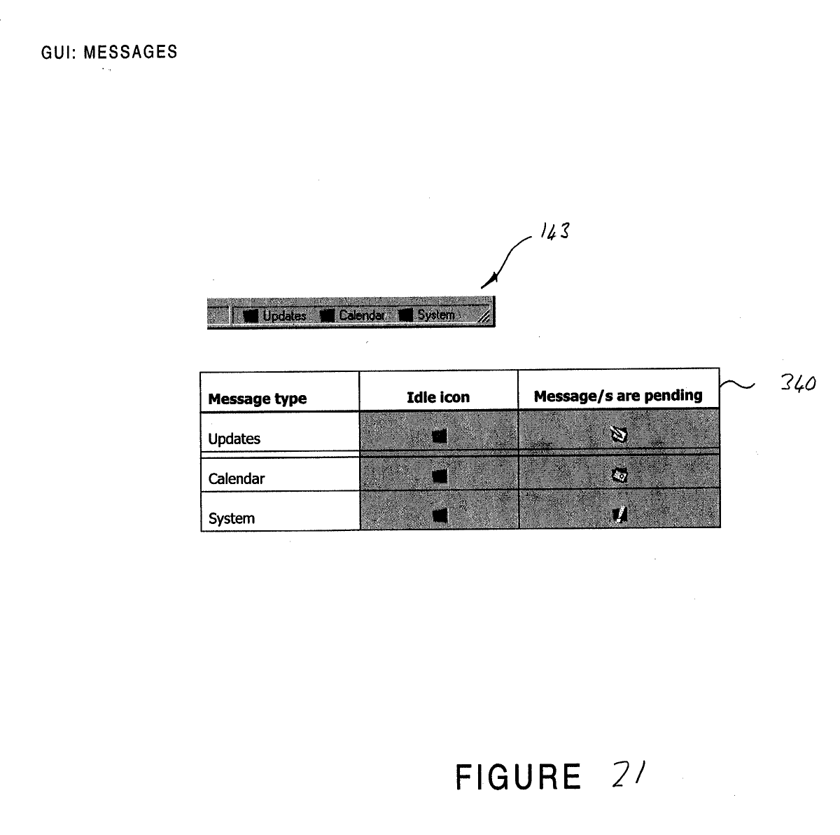

In order to keep a user, within a receiving role, apprised of all updates (e.g., both contact and calendar updates) that have occurred with respect to a local database 30 of the user, the present invention contemplates optionally providing messages to the relevant user detailing such updates. To this end, the status bar 142 includes a message status portion 143, illustrated in FIG. 8, and again reproduced in FIG. 21. An exemplary embodiment of the present invention contemplates that three types of messages may be generated for a user. These messages include an update message providing information regarding contact information updates, for example, resulting from modification to personal information of a contact published to the relevant user; a calendar message that indicates updates to the calendar of the user; and a system update message that typically comprises message from the application server 40 indicating that a further user may have added the relevant user to his or her contact information (i.e., accepted the publication of personal information from the user).

Upon updating of a local database 30 of a client application 18, the client services module 26 will then generate a number of messages, which are presented to the user via the GUI 24. To this end, when either a contact update, calendar update or system update message has been generated, an appropriate flashing icon will be provided within the message status portion 143 of the status bar 142. To this end, FIG. 21 illustrates a table 340 that shows exemplary icons that may be used to indicate an idle condition with respect to a particular message type, or further exemplary icons that may be generated and displayed within the message status portion 143 to indicate that messages are pending.

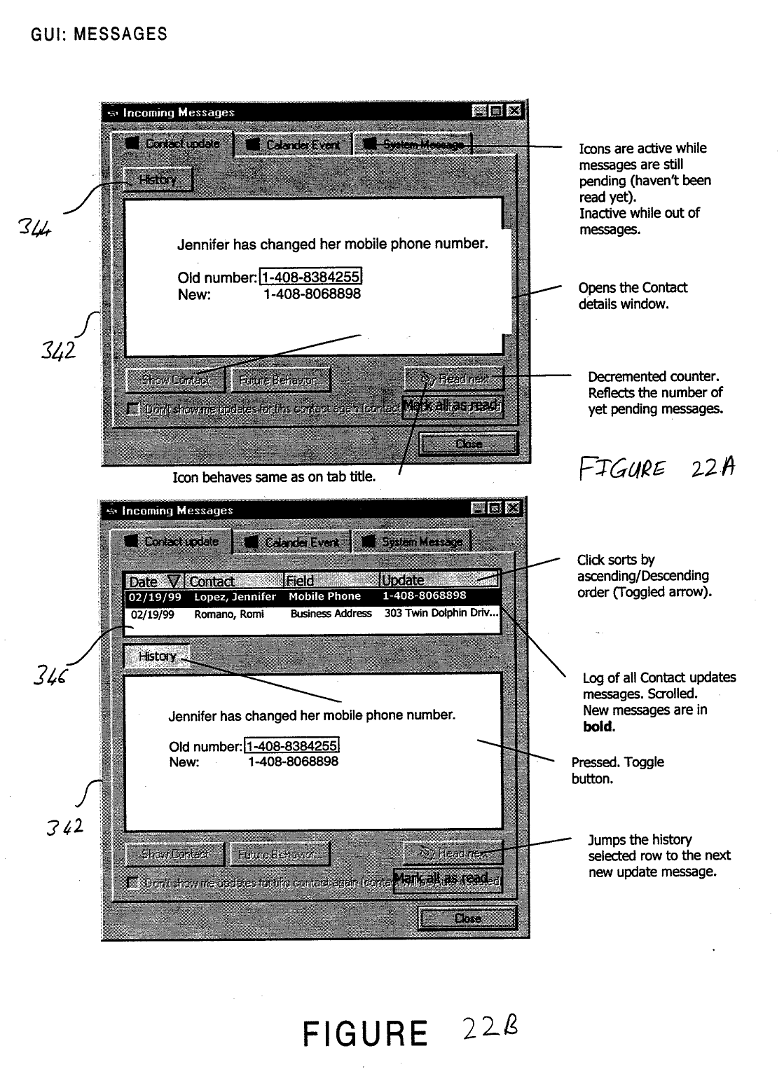

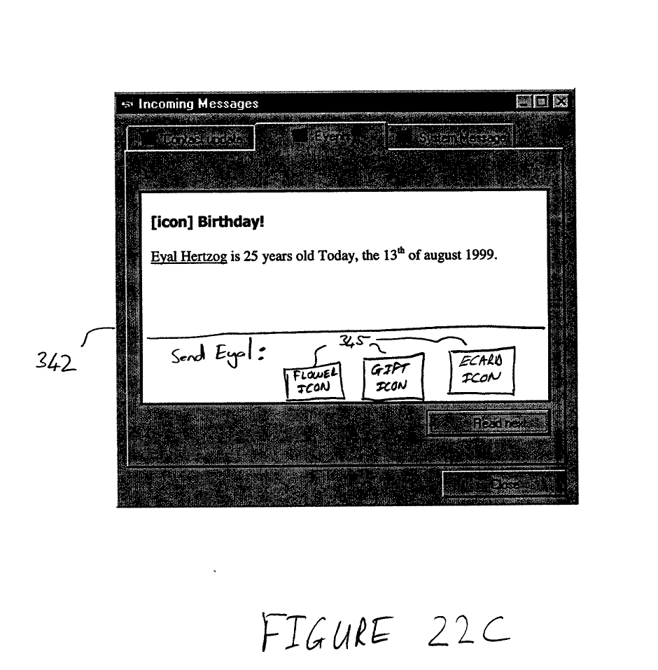

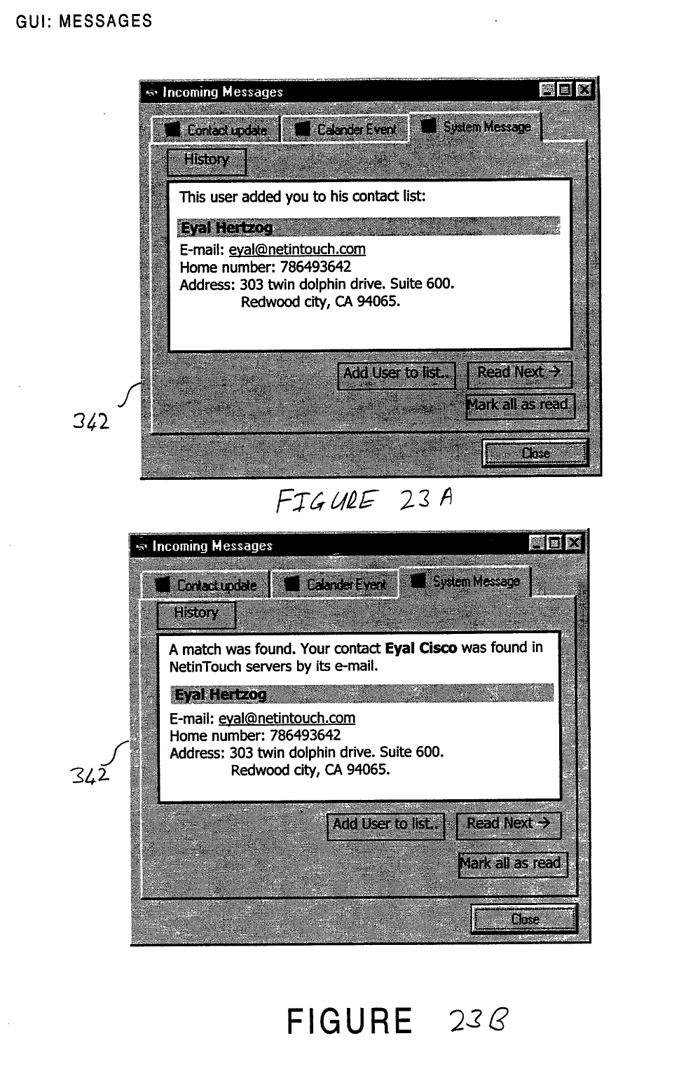

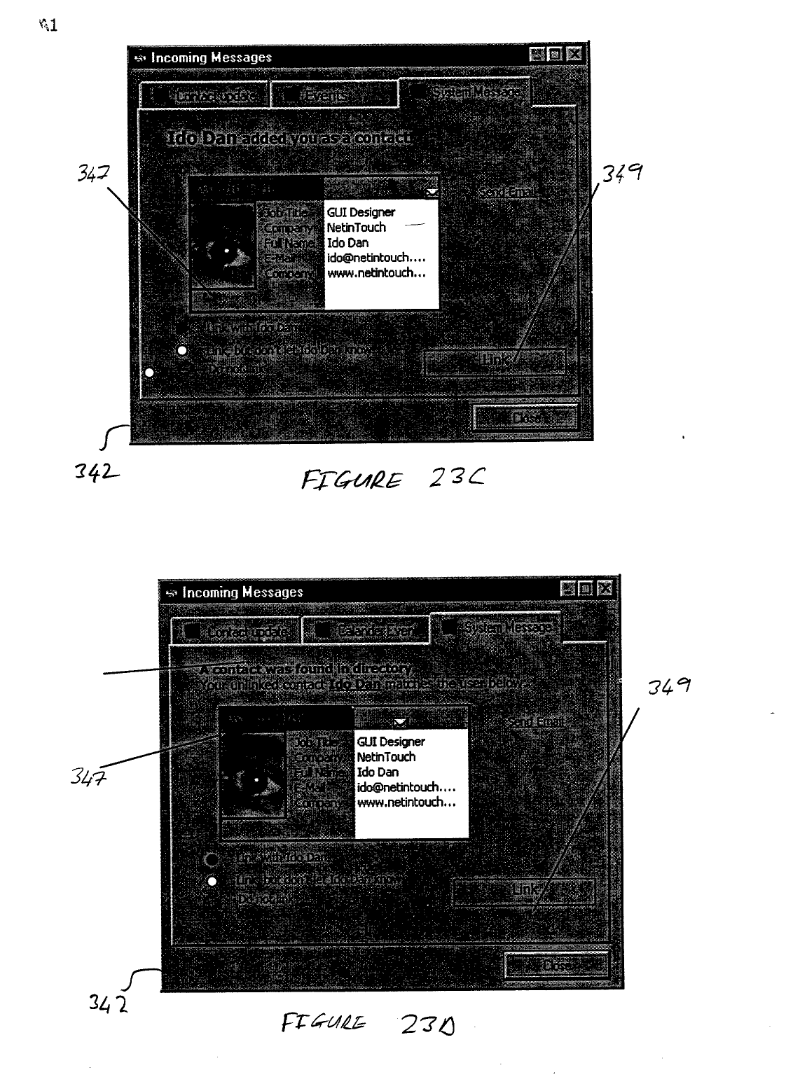

In order to view a message, the receipt of which is indicated by a flashing icon within the message status portion 143, the user may perform a user selection operation with respect to the relevant icon to generate a messages dialog block, examples of which are shown in FIGS. 22A-22C and 23A-23D. Specifically, FIG. 22A shows an incoming messages dialog block 342 that displays a message concerning the updating of a mobile phone telephone number by a publishing user, the incoming messages dialog block 342 being presented to a receiving user. It will be noted that the incoming messages dialog block 342 further provides three tabs, namely a contact update tab, a calendaring tab and a system message tab, which are user selectable to view the appropriate message types. Flashing message pending icons, such as those shown in the table 340, are included within the relevant tabs to indicate unread messages.

The incoming messages dialog block 342 further includes a “history” button 344, which is user-selectable to generate the history window 346 that lists a sorted “ascending or descending” sequence of contact update messages. The list of contact update messages presented in the history window 346 can be sorted by date in ascending or descending order by user selection of the arrow displayed adjacent the date column heading.

Calendar event messages, which are be displayed responsive to a user-selection of the calendar event tab of the incoming messages dialog block 342, could include birthday, meeting or other event reminders generated from calendar entries within the user's calendar. FIG. 22C illustrates an exemplary incoming messages dialog block 342 upon user selection of the events messages tab. It will be noted that the dialog block 342 also includes a number of user-selectable icons that may, in the manner described above with reference to FIG. 9C, be invoked to commence network-based communications with a relevant service provider.

FIG. 23A shows an example of the incoming messages dialog block 342 displayed upon user-selection of the system messages tab, and that displays an exemplary message. For example, the message displayed in FIG. 23A indicates that a receiving user has added the publishing user to his or her contact list by accepting publication of a virtual card 78. The message shown in the incoming messages dialog block 342 shown in FIG. 23B indicates the results of an automatic search instituted by the client services module 26 upon the entry of contact information by a user into the local database 30. In this case, the client services may automatically initiate, via the network 14, a search of the server database 34 to determine whether personal information for the contact being added to the local database 30 is also stored on the server database 34. In this case, the client services module 26, on prompting from the application server 40, will generate a message indicating that a match has been found between personal information inputted to the local database 30 by the GUI 24, and information stored on the server database 34.

FIGS. 23C and 23D illustrate further examples of the incoming messages dialog block 342 that correspond somewhat to the dialog blocks illustrated in FIGS. 23A and 23B. The illustrated dialog blocks differ, however, in that each includes a graphic representation of a virtual card 347, and also provides a user with the option of “linking” the shown virtual 347 into a user's local database 30 with notification to the relevant contact, linking the photo card into local database 30 without notification to the relevant contact, or not to link the relevant virtual card to a local database 30. Linking, according to the above option, may be invoked by user selection of a link button 349.

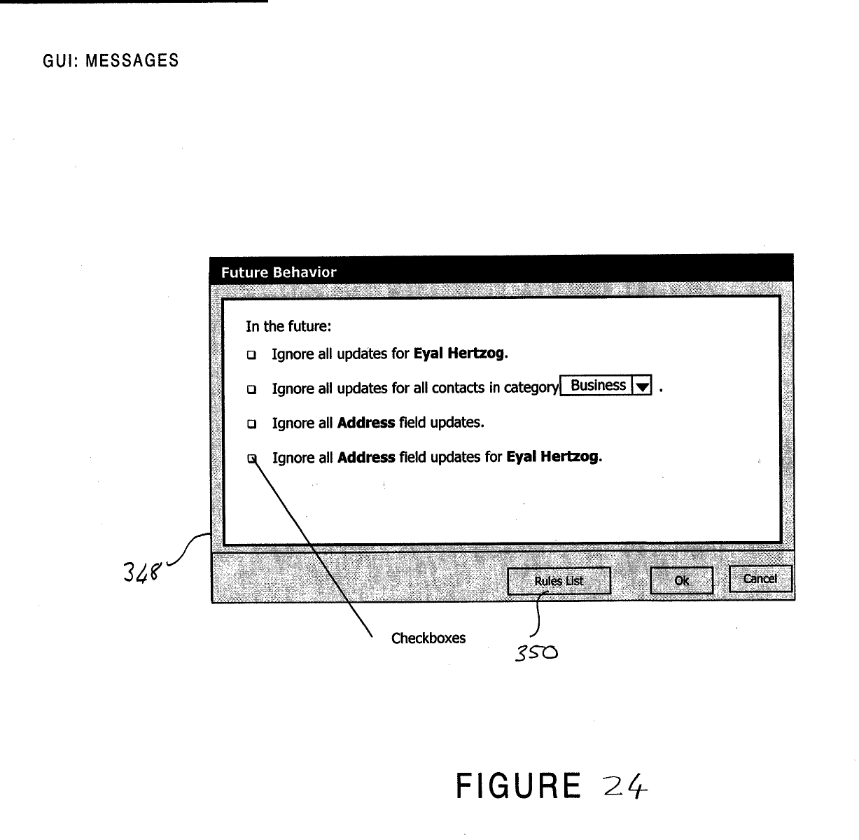

FIG. 24 is a screen shot of a future behavior dialog block 348, according to an exemplary embodiment of the present invention, utilizing which a user can implement a filter mechanism with respect to messages that are displayed in the incoming messages dialog block 342. For example, utilizing the future behavior dialog block 348, a user can disable the generation of contact update messages for all updates to her personal information of a specific user, for all updates of all contacts in a specific category, for all address field updates, or for all address field updates for a specific user. Further, by user selection of a “rules list” button 350, the user can specify customized rules that are user selectable to implement filter mechanisms.

A future behavior dialog block (not shown) may similarly be generated to institute filter mechanisms with respect to calendar event update messages. While it is envisaged that, in one exemplary embodiment, no system messages may be blocked or filtered, in a further embodiment, a future behavior dialog block (not shown) may be implemented to institute filter mechanisms with respect to system messages.

### Methodology—Display of Personal Information

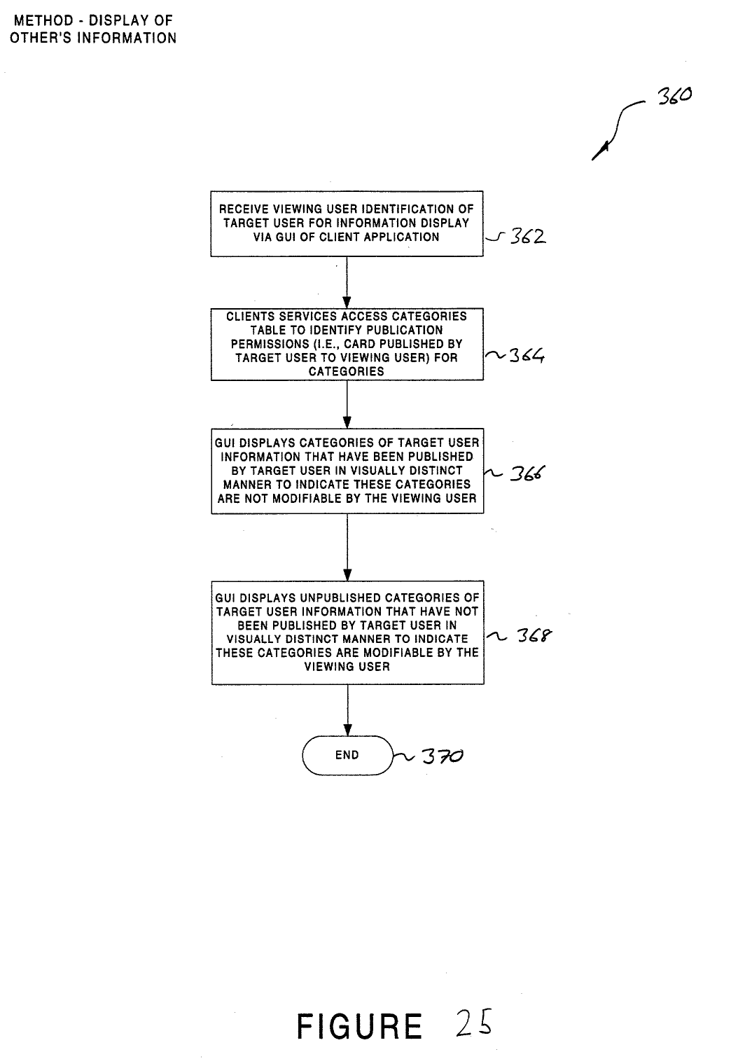

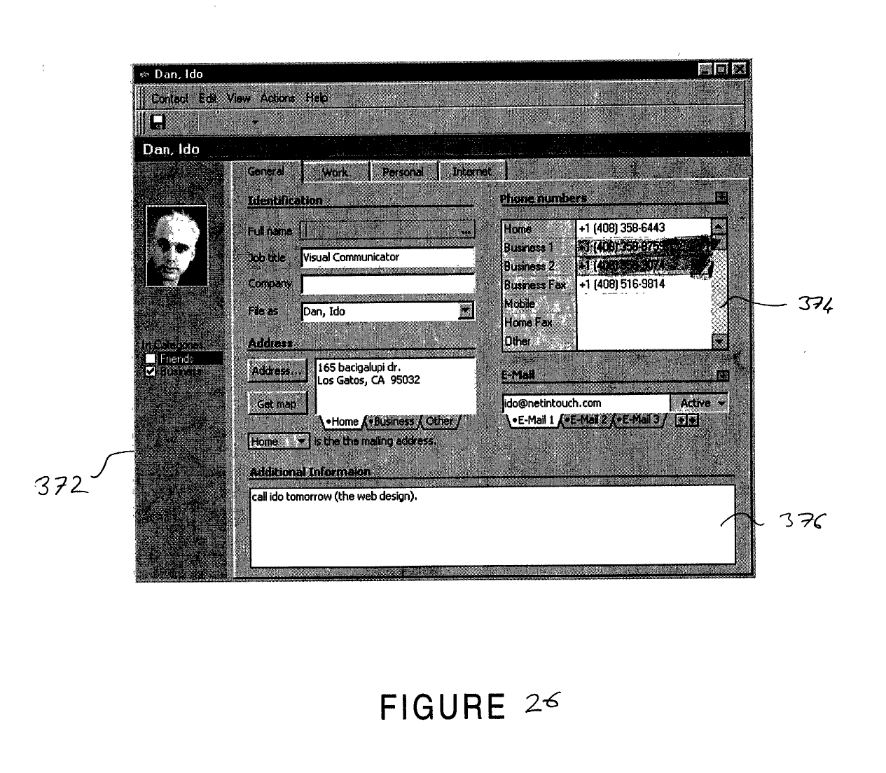

FIG. 25 is a flow chart illustrating a method 360, according to an exemplary embodiment of the present invention, of displaying fields of personal information concerning a first user in a manner so as to distinguish the personal information that is published and updateable by the first user from personal information that is inputted and updateable by a second user.

The method 360 commences at block 362 with the receipt by the client application 18 of an identification from a viewing user of a target user (i.e., a contact). This information is required to be displayed via the GUI 24 of the client application 18. The identification of the relevant contact may, merely for example, be determined by detecting a use-selection of a particular contact card 138 for the relevant contact within the browser panel 136 of the main window 130 shown in FIG. 8.

At block 364, the client services module 26 accesses the categories table 126 maintained within the local database 30. In an alternative embodiment, where personal information is stored within the server database 34 accessed via a browser 20, the client services module 26, or an equivalent structure, may access the server database 34 to identify publication permissions (i.e., whether a virtual card 78 for the identified target user has been published to the viewing user).

At block 366, the GUI 24 then displays a category of personal information concerning the target user (i.e., a sub-set of personal information that includes personal information fields 74 included within a virtual business card 78 published to the viewing user) in a visually distinct manner. This visual distinction is implemented in order to identify the personal information of the target user, as presented to the viewing user, that is non-modifiable by the viewing user and is published and updated by the target user.

FIG. 26 is a screen print showing a contact window 372, according to an exemplary embodiment of the present invention, that may be generated by the GUI 24 to display personal information (e.g., contact information) regarding the target user. Within the contact window 372, certain information fields may be visually distinguished from others in order to identify the relevant fields as containing information that is updated and published by the target user, and accordingly not updateable by the viewing user. For example, within the “phone numbers” window 374, the “business 1” and “business 2” telephone numbers may be displayed against a shaded background to indicate these personal information items as being owned, published and updated by the target user. It will of course be appreciated that the relevant personal information items could be visually distinguished in any manner.

Returning to the flow chart shown in FIG. 25, at block 368, the GUI 24 then displays unpublished categories of personal information regarding the target user to indicate that the relevant personal information items have been inputted by the viewing user, and accordingly are modifiable by the viewing user. It will be appreciated that these personal information items have not accordingly been published to the viewing user by the target user. Such personal information items may include, merely for example, information displayed in the “additional information” field 376, or any other personal information that the viewing user may have acquired and wish to store regarding the target user, and that has not been published by the target user.

The method 360 then ends at block 370.

In one embodiment of the present invention, the GUI 24 may provide a dialog block to the viewing user wherein the viewing user can customize the manner in which the fields of personal information that are local (i.e., maintained by the viewing user) and fields that are automatically updated (i.e., fields of personal information that are maintained by the target user) may be displayed in a visually distinct manner.

### Methodology—Display of History of Updates for Personal Information Field

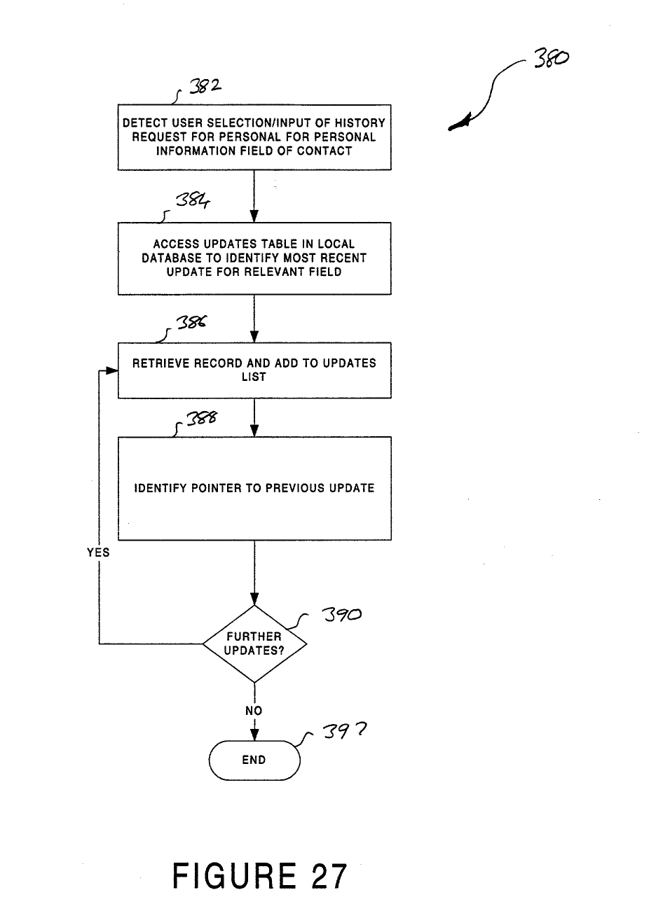

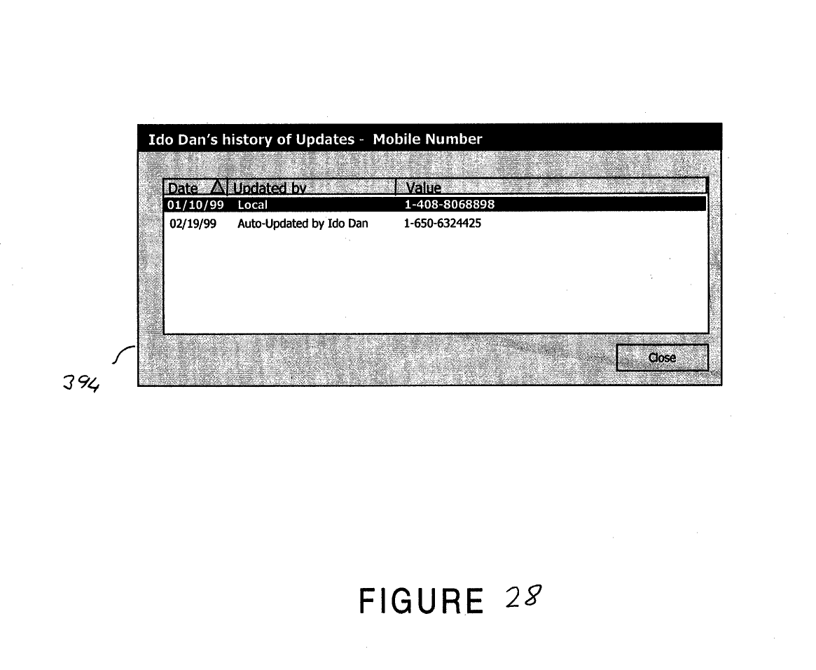

FIG. 27 is a flow chart illustrating a method 380, according to an exemplary embodiment of the present invention, of generating a list, or history, of updates to a specific information field of a specific contact, or user, whose information may be maintained either in the local database 30 or the server database 34.

The method 380 commences at block 382 with the detection by the client application 18 of user selection, or input, of a history request for a history of updates to a personal information field for a specific contact. For example, the user may perform a user selection operation with respect to any of the information fields displayed within the contact window 372 shown in FIG. 26 to perform the relevant user selection or input.

At block 384, the client services module 26 accesses the updates object 128 within the local database 30 to identify a most recent update for the relevant information field for the specific contact. At block 386, the client services module 26 retrieves the most recent update record, and adds the record to an update list for later display by the GUI 24. At block 388, the client services module 26 examines the “previous update” information item for the relevant record retrieved, this providing a pointer to the previous update record for the relevant personal information field for the specific user.

At decision block 390, a determination is made as to whether further update records for the relevant personal information field for the relevant user exists within the updates object 128. For example, if the “previous update” item has a zero value, or is blank, this indicates that no previous record updates exist. In this case, the method 380 terminates at block 392.

On the other hand, should the “previous update” information item point to a further record within the updates table 128, the method 380 then loops back to block 386, where such a further record is retrieved from the updates table 128, and the record is then added to the updates list for later display by the GUI 24. The method 380 loops through blocks 386, 388 and decision block 390, until no further update records are located.

Following the termination of the method 380, the constructed list of update records is communicated from the client services module to the GUI 24 for display within a history of updates window 394, such as that illustrated in FIG. 28. The history of updates may be sorted by date in an ascending or descending manner by user selection of the arrow adjacent the date column heading within the window 394.

### Methodology—Publication of Time Variant Personal Information

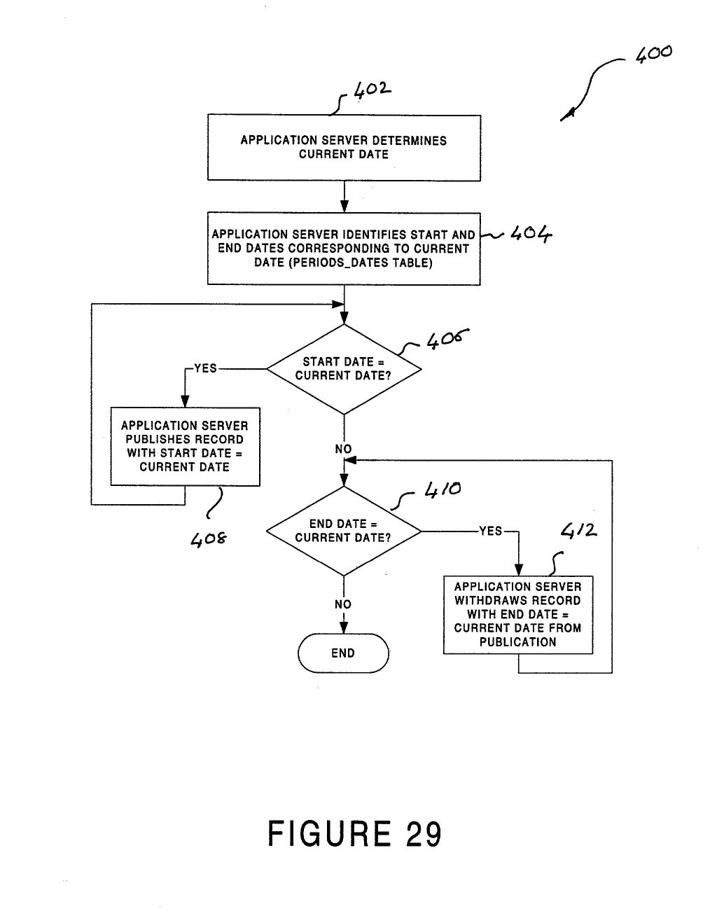

FIG. 29 is a flow chart illustrating a method 400, according to an exemplary embodiment of the present invention, of publishing time variant personal information from a publishing user to a viewing user. The publication contemplated by the method 400 is in accordance with the methodologies discussed above. While the methodology is described as being implemented within the context of the server farm 16, and specifically by the application server 40 in conjunction with the server database 34, it will be appreciated that the methodology could likewise be executed utilizing equivalent logic and data structures that exist on a client machine 12, and are embodied within the client application 18.

The method 400 commences at block 402 with a determination by the application server 40 of the current date.

At block 404, the application server then examines records within the periods_dates table 108, of the database structure 90 illustrated in FIG. 6, to identify any start or end dates corresponding to the current date determined at block 402.

At block 406, a determination is made as to whether any records having a start date, recorded in the start_date field, corresponding to the current date have been located.

If so, at block 404, the application server 40 then publishes a record, within the current_information table 104, having a period identifier (period_id) corresponding to the period identifier of the relevant record within the periods_dates table 108. The publication of the relevant record may occur, merely for example, by resetting a “deleted flag” (deleted_flag) maintained within the relevant record within the current_information table 104. Of course, as the information contained in the current information table 104 is subject to the permission model 98, publication will occur in accordance with permissions granted by the publishing user who owns the relevant information.

Following block 408, the method 400 loops back to the decision block 406, wherein a determination is made as to whether any further records exist within the periods_dates table 108 for which the start date corresponds to the current date. If not, the method 400 proceeds to decision block 410, where a further determination is made as to whether any records exist within the periods_dates table 108, for which the end date (end_dt) corresponds to the current date.

If so, records within the current information table 104 having a period identifier (period_id) corresponding to the period identifier of the relevant record within the periods dates table 108 are withdrawn from publication. Merely for example, this withdrawal from publication may be performed by setting (or toggling) a value stored in the deleted flag (delete_flag) field of the relevant record.

From block 412, the method 400 loops back to decision block 410, wherein a determination is made as to whether any further records within the periods_dates table 108 have end dates corresponding to the current date. If not, the method 400 then terminates at block 414.

It will be appreciated that the method 400 provides a convenient vehicle by which a publishing user can attach a time interval to certain information over which that information will be published. For example, where a publishing user relocates to a temporary location for a predetermined period, the publishing user may then pre-specify dates at which contact information for the temporary location would be published to all subscribers to his or her personal information.

As a default, the start and end dates for period records associated with each of the records in the current_information table 104 are set to infinite start and end dates, so that these records are viewed as valid and published at all times. However, in one exemplary embodiment, the GUI 24 provides a mechanism via which a user may attach a time interval to specific information to cause this information to be published over a predetermined time interval.

### Methodology—Retrieving On-Line Information Pertaining to a Contact

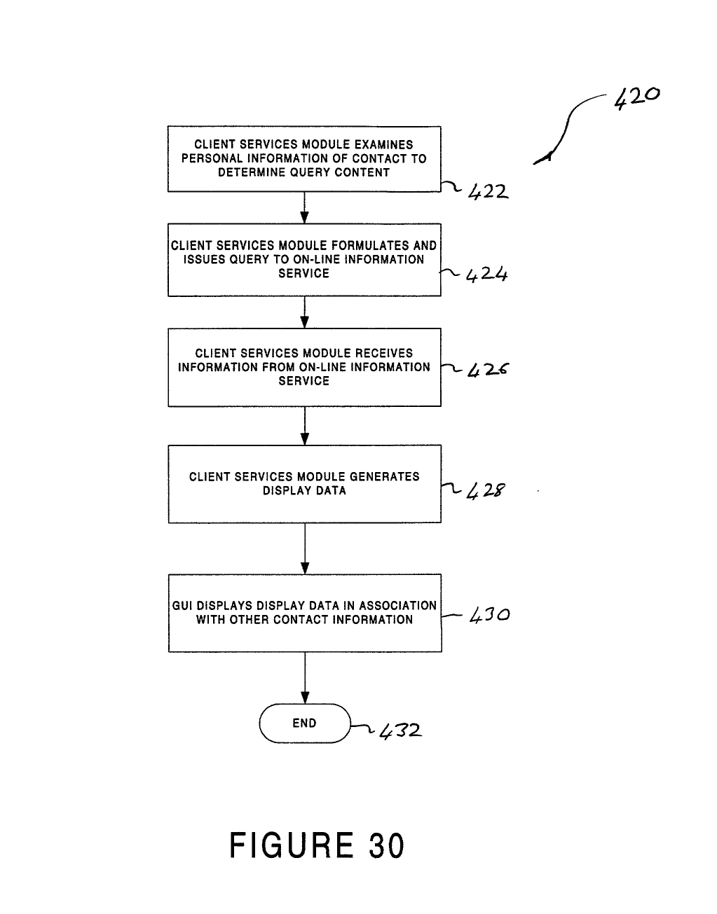

FIG. 30 is a flow chart illustrating a method 420, according to an exemplary embodiment of the present invention, of retrieving on-line and possibly real-time or near real-time information, pertaining to a contact whose information may be stored either in the local database 30 of the client application 18, or on the server database 34 at the server farm 16.

Information maintained in a PIM 22 or a PDA 32 is typically static in nature, and includes comprises contact, calendar and associated information. In order to enhance the information presented to a viewing user regarding a specific contact, the present invention contemplates accessing stored personal information regarding that particular contact and, utilizing the stored information, formulating a query to an on-line service, or information source, to obtain further information pertaining to the contact, or to enhance the stored information regarding the contact. For example, the present invention proposes utilizing the address of a contact to retrieve on-line information concerning a home or work location for the relevant contact. It is further envisaged that local time information, map information, stock price information, company information, or any other on-line information, could be automatically retrieved utilizing the personal information of a contact and displayed within the context of a PIM, such as the client application 18. In one exemplary embodiment, as described above with reference to FIG. 9C, the formulated query may be in the form of a URL that embodies both personal information regarding a contact (e.g., address information) and an identifier identifying the client application 18 (or a developer or supplier of the client application 18). In this way, the on-line information service is able to generate a contact-specific response to the query, and to identify the query as having originated via a client application 18.

The method 420 commences at block 422 with an examination by the client services module 26 of personal information concerning a contact, as stored within the local database 30, to determine a query content. For example, city, country, address or company address could be examined and retrieved for the purposes of populating a query.

As block 424, the client services module 26 formulates and issues a query (e.g., embodied within a URL of a HTTP GET request), utilizing the information retrieved at block 422, to an on-line information source or service. For example, city, state and country information may be propagated to an online weather service with a view to querying the weather service regarding current weather conditions (e.g., temperature, cloud cover, humidity, wind speed, visibility and dew point information). The query (e.g., a GET request) to the on-line information source or service is propagated over the network (e.g., the Internet) using any one of many well known network protocols (e.g., HTTP, FTP or any other well know protocol).

At block 426, the client services module 26 of the client application 18 receives information from the on-line information service via the network 14.

At block 428, the client services module 26 then generates information for display by the GUI 24, based on the information received from the on-line information service responsive to the query generated at block 424. For example, the client services module 26 may extract only specific pertinent information to be displayed by the GUI 24, and may further access various graphics or icons based on the received information to supplement and enhance the visual display thereof. For example, the client services module 26 may access a database of weather icons to identify an icon to communicate weather conditions at the contacts home location. The client services module 26 then communicates this information to the GUI 24.

At block 430, the GUI 24 then displays the information received from the client services module 26 in a manner so as to associate the relevant information with the contact. For example, referring to FIG. 9, within the services section 160, weather and local time information are shown to be displayed at 162 and 164 respectively for a location identified by the relevant contact's address location (i.e., Los Gatos, Calif.). It will furthermore be noted that, for the weather information indicated at 162, an icon is displayed to indicate that sunny and warm conditions are currently being experienced at Los Gatos, Calif. A “moon and stars” icon is furthermore utilized to visually supplement the time information displayed at 164 by indicating that it is currently evening, or night, at the relevant location. Further information that could be displayed includes the current stock price of a company by which the relevant contact is employed, and a map providing a visual indication of a home or work address of the contact.

While the presentation and display of data retrieve from an on-line information service is described above as being displayed by the client application 18, it will readily be appreciated that such information returned from an on-line information server responsive to the query may also be displayed within the browser 20. For example, responsive to a request for weather information, the browser could be invoked to display the current and projected weather conditions within the residential city of a relevant contact.

It will also be appreciated that the on-line service may not necessarily be purely an information service, but may also be a product or service vendor. For example, as described above, with reference to FIG. 9C, the query formulated and issued at block 424 may be presented to a product vendor, such as a flower vendor. In this case, address details for a contact may be communicated to a web site operated by a flower vendor. The relevant user would in this case not have to manually input or otherwise directly supply address information for the contact to the flower vendor. The web site of the flower vendor may return a markup language document page, for display by the browser 20, that enables the user to specify and conclude a transaction for the purchase of a product to be shipped to the address of the relevant contact. In this case, the relevant address information may again be communicated to the flower vendor within a URL, or other data structure, that is communicated as part of a GET request according to the HTTP protocol.

The presentation of such supplemental information concerning or associated with a contact within the services section 160, or within the browser 20, is advantageous in that it provides supplementary, or additional, information based on the supplied contact information. For example, the display of a map indicating a home address of the contact can be regarded as enhancing the already known information regarding the contact. On the other hand, the weather, time and stock price information can be regarded as new, or additional, information that is retrieved based on know information regarding the relevant contact. The display of weather information at 162 is particularly advantageous in that it may form the basis for initiating a conversation with a contact whose contact details have been retrieved from a PIM, such as the client application 18, for the purposes of initiating a phone call. The time information displayed at 164 is advantageous in that it may prevent a user that retrieved the contact information for the purpose of making a telephone call from calling the contact at an inappropriate time. For example, where the contact in a foreign country, the caller may be alerted to the fact that relevant contact may in fact not be at a work address, or awake at home, at the time that the caller intended to make the call.

Similarly, stock price information, company news (e.g., Reuters headlines), geographic news or sports news may provide the caller with useful information with which to initiate a conversation with the relevant contact.

It will furthermore be noted that the information may be displayed in a manner so as to associate the displayed information with the relevant contact whose contact information was utilized to formulate the query at block 424.

Following the display of the information at block 430, the method 420 then terminates at block 432.

While the method 420 is described as being implemented by the client services module 26 of a client application 18 residing on the client machine, the blocks of the method 420 could be performed by the application server 40, utilizing information stored on the server database 34, to support an on-line PIM environment, such as that provided by Yahoo, Incorporated (e.g., the Yahoo! Contacts and Yahoo! Calendar services). The method 420 is furthermore not limited to a system wherein personal information is published from a publishing user to a receiving user, as described above, and could simply be utilized to supplement a local or on-line contact or calendar information maintained by a user.

### Methodology—The Inclusion of Audio and/or Image Data Within a Set of Personal Information Records Maintained by a Personal Information Manager (PIM)

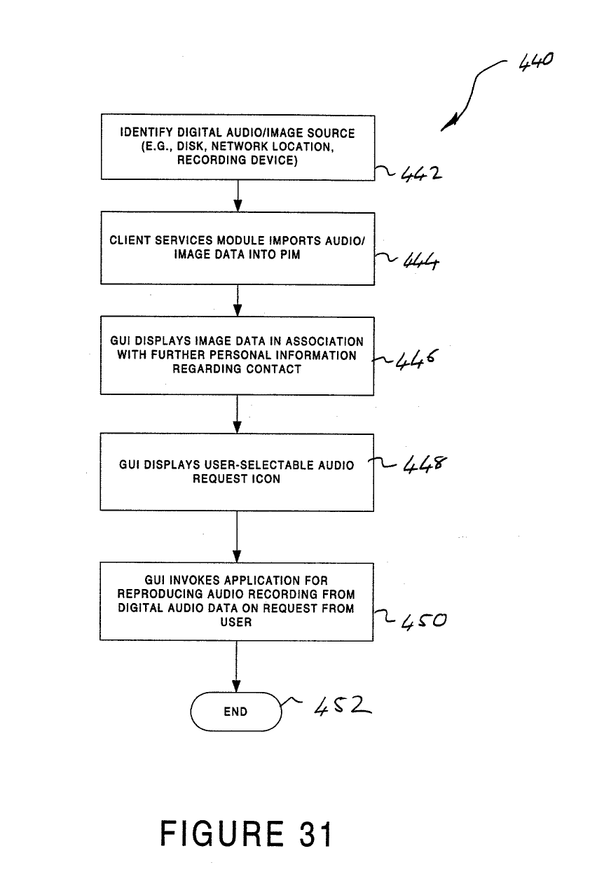

FIG. 31 is a flow chart illustrating a method 440, according to an exemplary embodiment of the present invention, of including audio and/or image data within a set of personal information records, maintained within a personal information manager (PIM) for a specific contact. Image data shall, for the purposes of the present specification, be understood to include data from which both a stored image (e.g., JPEG, GIF, TIFF or bitmap formatted data) can be reproduced or image data from which a moving or a video image can be reproduced (e.g., MPEG or quicktime formatted data).

The method 440 commences at block 442 with the identification of a source for the digital audio or image data to be included within, or associated with, personal information for a contact. The relevant source may comprise a storage medium, such as a magnetic or optical diskette, a network location at which the relevant data is stored (e.g., an Internet location from which an image may be imported) or a recording device from which the information may be directly obtained (e.g., a digital camera, digital video camera or microphone coupled to a sound card).

At block 444, the client services module 26 then operates to import the relevant audio and/or image data into the client application 18, where it is stored in a main memory, or temporary memory, associated with the client machine 12. At block 446, the client services module 26 associates the inputted audio and/or image data with a particular contact. To this end, the client services module identifies a particular contact as having been user selected, via the GUI 24, for association with the audio and/or image data. Accordingly, at block 446, the relevant audio and/or image data is included within, or associated with, the personal information record maintained by the client application 18 for the relevant contact within the local database.

At block 448, the GUI 24 may optionally interpret and display the image information in association with further contact information regarding the contact. To this end, reference is made, for example, to FIG. 9A, where a digital image 166 of the contact is included within the contact details panel 152 within the main window 130 presented by the GUI 24.

Referring to FIG. 12, in one exemplary embodiment of the present invention, multiple sets of digital image information may be included within the personal information records of a particular contact. In this case, the viewing user may be presented with a mechanism, such as the advance and retreat buttons 220, by which the viewing user may select one of a number of images to be displayed in association with other contact information pertaining to the relevant contact.

Where the audio and/image information pertains to a publishing user, in the context described above, this information may furthermore be included within a sub-set of personal information that is published from the publishing user to a viewing user, in the form of a virtual card 78.

Returning to the flow chart shown in FIG. 31, at block 449, the GUI 24 may optionally display a user-selectable audio request icon, via which a viewing user may request reproduction of the audio recording embodied within the stored audio information. An example of such an icon is shown in FIG. 12 at 222.

At block 450, responsive to user selection of the audio request icon displayed at block 449, the GUI 24 may then call and execute a sound reproducing program that reproduces the audio recording embodied within the stored digital audio information.

The method 440 then ends at block 452.

The above described method 440 of associating audio and/or image data with other personal information stored, for example, within the context of a PIM, is particularly advantageous in that it supplements the personal information in a personalized manner. By facilitating the association of digital image data with other personal information stored, for example, within the context of PIM, a visual reminder of the appearance of a contact can be provided. Furthermore, the stored audio data can provide a reminder, or information concerning the correct pronunciation, of a particular contacts name. This information is particularly useful in situations where a contact may not be seen on a regular basis, and a memory of the visual appearance may become faded within a user's memory. Furthermore, where the pronunciation of a particular contacts name is foreign to a particular user, the audio reproduction of a correct pronunciation of that name may be particularly useful.

In an exemplary embodiment of the present invention, it is envisaged that the above described audio and/or image data may be included within a sub-set of personal information that is published, via the personal information publication system described above, from a publishing user to a receiving user. Within the context of the system illustrated in FIG. 1, audio and/or image data may be stored within multiple records for a particular user within the blob table 114 illustrated as forming part of the database structure 90 shown in FIG. 6.

While the image data is described above as comprising, for example, a digital photograph of the face of a contact, it is envisaged that the digital image information could represent any other visual icon or picture associated with the contact. For example, the logo of an organization or company that employs the contact could also be stored and reproduced as part of the personal information pertaining to the contact. The audio data may also, merely for example, include a audio greeting that a viewing user can invoke.

### Computer System

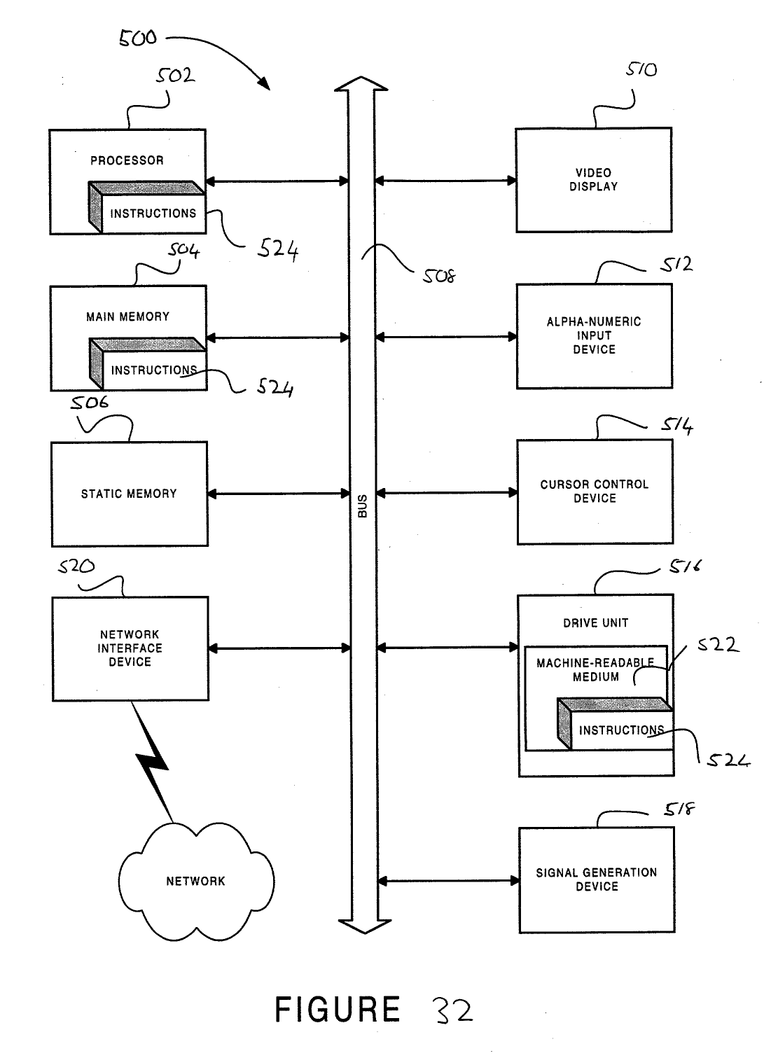

FIG. 32 is a block diagram providing a representation of a machine, in an exemplary form of a computer system 500, that may comprise the client machine 12, server machine within the server farm 16, or any one of a series of server machines implementing a web-based e-mail service. A set of instructions, for causing the computer system 500 to perform any one of the methodologies discussed above, may be executed within the computer system 500. The computer system 500 includes a processor 502, a main memory 504 and a static memory 506 that communicate with each other via a bus 508. The computer system 500 is further shown to include a video display unit 510 (e.g., a liquid crystal display (LCD) or a CTR). The computer system 500 also includes an alpha-numeric input device 512 (e.g., a keyboard), a cursor control device 514 (e.g., a mouse), a disk drive unit 516, a signal generation device 518 (e.g., a speaker) and a network interface device 520.

The disk drive 516 includes a machine-readable medium 522 on which is stored a set of instructions (i.e., software) 524 embodying any one or all of the methodologies for implementing the present invention. The software 524 may comprise the client application 18, or any of the modules that constitute the client application 18 and application server 40, a web server 42, a DBMS 44, a browser 20, or any other PIM 22 that embodies instructions for implementing any of the concepts of the present invention.

The software 524 is also shown to reside, completely or at least partially, within the main memory 504 and/or within the processor 502.

The software 524 may furthermore be transmitted and received by the network interface device 520.

For the purposes of the present specification, the term “machine-readable medium” shall be taken to include any medium that is capable of storing and coding a sequence of instructions for execution by a machine, that causes the machine to perform any one of the methodologies of the present invention. The term “machine-readable medium” shall accordingly be taken to include, but not be limited to, solid-state memories, optical and magnetic disks and carrier wave signals.

As stated above, it is envisaged that the present invention could be implemented utilizing three paradigms. In a first paradigm, a single server database 34 stores all personal information that is managed by a user, and from which specified views are published to other users. In a second paradigm, a number of local databases 30 are maintained on a number of client machines, each of the local databases comprising a subset of a server database 34. In this second paradigm, the local databases 30 are periodically synchronized with the server database 34, in this way facilitating the publication of information from one local database 30 to another local database 30. A third paradigm obviates the need for the server database 30, and contemplates that information is published directly between local databases 30 over a network.

The use of a local client application 18, which may for example comprise a PIM maintaining a local database 30, is advantageous in that it enables a user to look up information when the client machine 12 is off-line, or not connected to the network 14. Further, by implementing the PIM as a local client application 18, as opposed to a web-based service, a more dynamic, responsive and complex user interface may be implemented. For these reasons, the second paradigm discussed above (i.e., having a number of local databases 30 that are synchronized with a server database 34) provides an attractive option in that it provides the advantages of a stand-alone client-based PIM with the synchronization and publishing features of a web-based service.

Thus, a method and system to automate the updating of personal information within a personal information management application, and to synchronize such updated personal information across multiple personal information management applications, have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method including:
storing first personal information concerning a user to be accessed by a personal information management application, the first personal information being associated with a first event occurrence;
storing second personal information concerning the user to be accessed by the personal information management application, the second personal information being associated with a second event occurrence;
based on the first event occurrence, validating the first personal information for access by the personal information management application; and
based on the second event occurrence, validating the second personal information for access by the personal information management application;
wherein the first and second personal informations are not simultaneously validated for access by the personal information management application.

2. The method of claim 1 wherein the first and second event occurrences comprise respective commencements of first and second time intervals associated with the first and second personal informations.

3. The method of claim 2 wherein at least the first time interval indicates a start time and an end time during which the first personal information is valid.

4. The method of claim 1 wherein the first and second event occurrences comprise the respective commencements of first and second date intervals associated with the first and second personal informations respectively.

5. The method of claim 4 wherein at least the first date interval indicates a start date and an end date between which the first personal information is valid.

6. The method of claim 1 including, following validation of the first personal information for access by the personal information management application, publishing the first personal information from the first information management application to multiple further personal information management applications so as to update respective records concerning the user maintained by each of the multiple further personal information management applications.

7. The method of claim 6 wherein the first personal information is published via a network to which a computer system hosting the personal information management application is coupled.

8. The method of claim 1 wherein the first personal information comprises contact information and the first event occurrence comprises a commencement of a time period during which the contact information is valid for the user.

9. A system comprising:
a database to store first personal information concerning a user to be accessed by a personal information management application, the first personal information being associated with a first event occurrence, and to store second personal information concerning the user to be accessed by the personal information management application, the second personal information being associated with a second event occurrence; and
the personal information management application to, based on the first event occurrence, validate the first personal information for access from the database and to, based on the second event occurrence, validate the second personal information for access from the database.

10. A machine-readable medium storing a sequence of instructions that, when executed by the machine, cause the machine to:
store first contact information concerning a user, the first contact information being associated with a first event occurrence;
store second contact information concerning the user, the second contact information being associated with a second event occurrence;
based on the first event occurrence, validate the first contact information for access by a contact management application; and
based on the second event occurrence, validate the second contact information for access by the contact management application,
wherein the first and second contact information is not simultaneously validated for access by the contact management application.
